(19) United States
(12) Patent Application Publication
(10) Pub. No.: US 2025/0357544 A1
(43) Pub. Date: Nov. 20, 2025

(54) CARBONATE COMPOUNDS FOR ENERGY STORAGE DEVICE ELECTROLYTE COMPOSITIONS, AND METHODS THEREOF

(71) Applicant: Tesla, Inc., Austin, TX (US)

(72) Inventors: Jeffery R. Dahn, Halifax (CA); Tina Taskovic, Halifax (CA); Alex Carpenter, Seabrook, TX (US); Quinton Meisner, Broomfield, CO (US); Alireza Ostadhossein, Newark, CA (US)

(21) Appl. No.: 18/869,204

(22) PCT Filed: Jun. 8, 2023
(86) PCT No.: PCT/US2023/068135

§ 371 Date: Nov. 25, 2024

Related U.S. Application Data
(60) Provisional application No. 63/351,267, filed on Jun. 10, 2022.

(51) Int. Cl. H01M 10/0569; H01M 10/0525; H01M 10/054; H01M 10/0568; H01M 10/058

(52) U.S. Cl. CPC H01M 10/0569; H01M 10/0525; H01M 10/054; H01M 10/0568; H01M 10/058; H01M 2300/0037

(57) ABSTRACT

Provided herein are electrolyte solvents, co-solvents, and formulations for energy storage devices having improved performance. The improved performance may be realized as improved cycling stability in addition to coulombic efficiency, capacity, or conductivity at exceptionally high temperatures (e.g., at least about 70° C. or about 70-85° C.). Such electrolyte formulations may include a compound of Formula (I), such as dimethyl 2,5-dioxahexanedioate (DMOHC) and diethyl 2,5-diox-ahexanedioate (DEOHC).

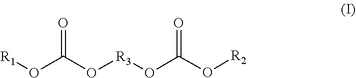

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. The present application claims priority to U.S. Provisional Patent Application No. 63/351,267, titled “CARBONATE COMPOUNDS FOR ENERGY STORAGE DEVICE ELECTROLYTE COMPOSITIONS, AND METHODS THEREOF,” filed Jun. 10, 2022, the disclosure of which is incorporated herein by reference in its entirety and for all purposes.

### BACKGROUND

### Field

The present disclosure relates generally to energy storage devices, and specifically to improved electrolyte formulations for use in energy storage devices.

### Description of the Related Art

Energy storage devices are widely used to provide power to electronic, electromechanical, electrochemical, and other useful devices. Such cells include primary chemical cells, secondary (rechargeable) cells, fuel cells, and various species of capacitors, including ultracapacitors. Increasing the operating voltage and temperature of energy storage devices, including batteries and capacitors, would be desirable for enhancing energy storage, increasing power capability, and broadening real-world use cases.

Lithium ion batteries have been relied on as a power source in numerous commercial and industrial uses, for example, in consumer devices, productivity devices, and in battery powered vehicles. However, demands placed on energy storage devices are continuously—and rapidly—growing. For example, the automotive industry is developing vehicles that rely on compact and efficient energy storage, such as plug-in hybrid vehicles and pure electric vehicles. Lithium ion batteries are well suited to meet future demands however improvements in energy density are needed to provide longer life batteries that can travel further on a single charge. The electrolyte is one component in conventional lithium ion batteries that determines electrochemical performance as well as safety of those batteries, where the compatibility between electrode and electrolyte in part governs battery cell performance.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, an energy storage device is described. The energy storage device comprises: a cathode; an anode; a separator disposed between the cathode and the anode; and an electrolyte comprising a solvent and an alkali metal salt, wherein the solvent comprises a compound of Formula (I):

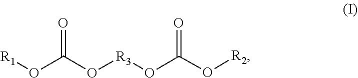

wherein: R₁ and R₂ are each independently an optionally substituted C₁₋₁₂ alkyl; and R₃ is an optionally substituted C₁₋₁₂ alkylene.

In some embodiments, R₁ and R₂ are each independently selected from the group consisting of methyl and ethyl; and R₃ is (—CH₂CH₂—). In some embodiments, R₁ and R₂ are each independently selected from the group consisting of an optionally substituted methyl, an optionally substituted ethyl. an optionally substituted propyl, an optionally substituted butyl, an optionally substituted iso-propyl, an optionally substituted iso-butyl, and an optionally substituted sec-butyl. In some embodiments, the R₁ and R₂ optional substitutions are each independently selected from at least one halogen. In some embodiments, the R₃ optional substitutions are selected from the group consisting of at least one C₁₋₁₂ alkyl, C₁₋₁₂ haloalkyl, halogen, and combinations thereof. In some embodiments, R₃ is an optionally substituted ethylene or an optionally substituted propylene.

In some embodiments, the compound is represented by Formula (Ta):

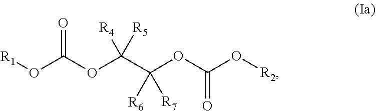

wherein R₄, R₅, R₆, and R₇ are each independently selected from the group consisting of —H, a halogen, a C₁₋₁₂ alkyl, and a C₁₋₁₂ haloalkyl. In some embodiments, R₄, R₅, R₆, and R₇ are each independently selected from the group consisting of —H, CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃. In some embodiments, R₄ is selected from the group consisting of —H, CH₃—, CH₃CH₂—, CH₃CH₂CH(CH₃)—, (CH₃)₃C—, and —CF₃. In some embodiments, R₅ is selected from the group consisting of —H, CH₃—, CH₃CH₂—, CH₃CH₂CH(CH₃)—, (CH₃)₃C—, and —CF₃. In some embodiments, R₆ is selected from the group consisting of —H, CH₃—, CH₃CH₂—, CH₃CH₂CH(CH₃)—, (CH₃)₃C—, and —CF₃. In some embodiments, R₇ is selected from the group consisting of —H, CH₃—, CH₃CH₂—, CH₃CH₂CH(CH₃)—, (CH₃)₃C—, and —CF₃.

In some embodiments, the compound is represented by Formula (Ib):

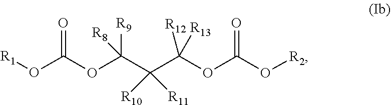

wherein R₈, R₉, R₁₀, R₁₁, R₁₂, and R₁₃ are each independently selected from the group consisting of —H, a halogen, a C₁₋₁₂ alkyl, and a C₁₋₁₂ haloalkyl.

In some embodiments, the compound of Formula (I) is selected from the group consisting of

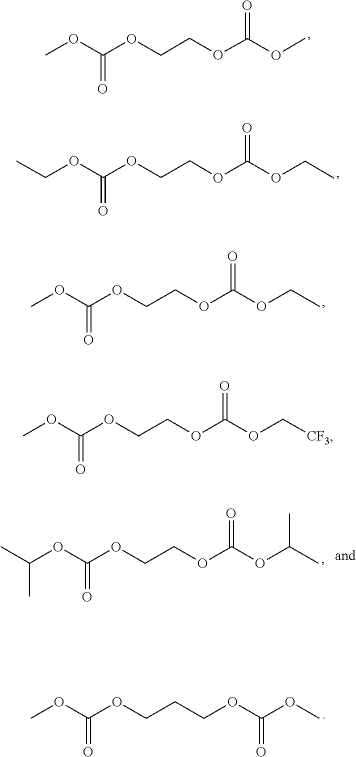

In some embodiments, the compound of Formula (I) is selected from the group consisting of

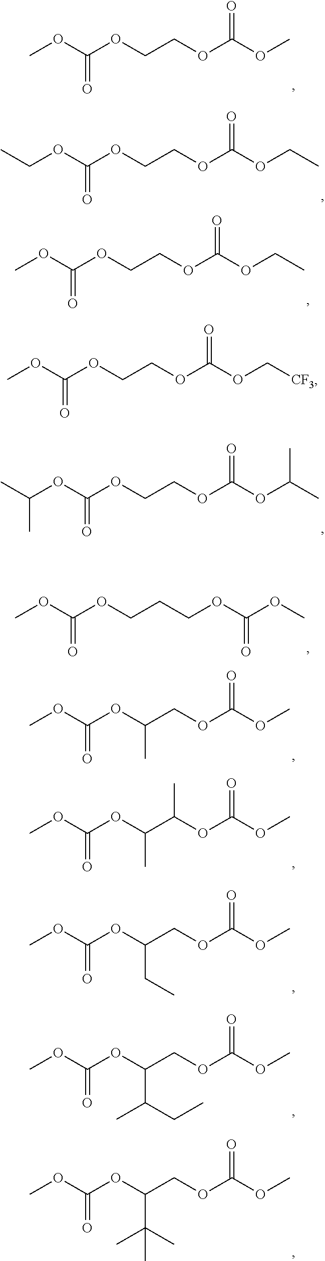

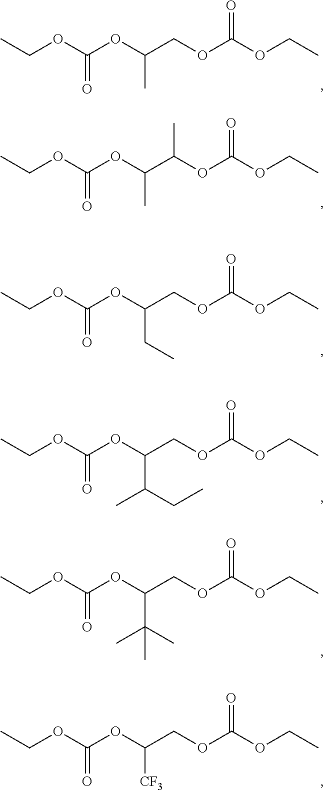

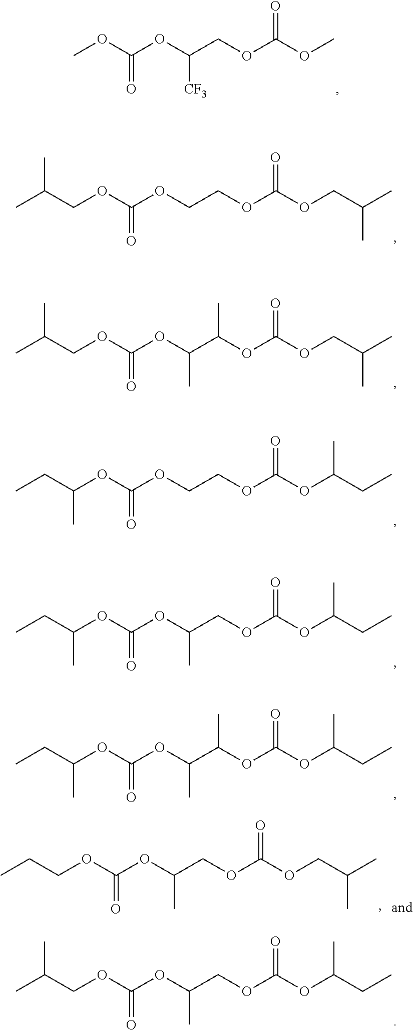

In some embodiments, the alkali metal salt is a sodium salt. In some embodiments, the alkali metal salt is a lithium salt. In some embodiments, the lithium salt is LiFSI. In some embodiments, the electrolyte further comprises a second solvent selected from the group consisting of ethylene carbonate (EC), propylene carbonate (PC), vinyl ethylene carbonate (VEC), vinylene carbonate (VC), fluoroethylene carbonate (FEC), dimethyl carbonate (DMC), diethyl carbonate (DEC), ethyl methyl carbonate (EMC), methyl acetate (MA), ethyl acetate (EA), propionitrile (PN), acetonitrile (AN), butyrolactone (GBL), and combinations thereof. In some embodiments, the solvent further comprises dimethylcarbonate (DMC). In some embodiments, the ratio between the solvent and second solvent is about 1:4 to about 4:1.

In some embodiments, the energy storage device of the present disclosure has at least 96% retention of initial capacity after 2,000 hours of cycling when operated between 3.0 V and 4.3 V. In other embodiments, the energy storage device of the present disclosure has greater than 99% retention of initial capacity after 2000 hours of cycling when operated between 3.0 and 3.8 V at a temperature of at least 70° C.

In another aspect, a method of preparing an energy storage device is described. The method comprises: disposing a cathode, an anode, a separator disposed between the cathode and the anode, and an electrolyte within a housing; wherein the electrolyte comprises a solvent and an alkali metal salt, wherein the solvent comprises a compound represented by Formula (I):

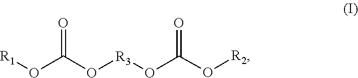

wherein: R₁ and R₂ are each independently an optionally substituted C₁₋₁₂ alkyl; and R₃ is an optionally substituted C₁₋₁₂ alkylene.

### BRIEF DESCRIPTION OF THE DRAWINGS

FIG. 1A is a phase diagram of mixtures of dimethyl carbonate (DMC) and dimethyl 2,5-dioxahexanedioate (DMOHC) at various temperatures.

FIG. 1B is a phase diagram of mixtures of dimethyl carbonate (DMC) and ethylene carbonate (EC) at various temperatures.

FIG. 2A is a data plot of the viscosity versus temperature of electrolyte solutions and solvent combinations according to some embodiments relative to baseline electrolyte systems.

FIG. 2B is a data plot of the viscosity versus temperature of electrolyte solutions and solvent combinations according to some embodiments relative to baseline solvent combinations.

FIG. 3 is a data plot showing the normalized discharge capacity versus cycle time of NMC532/artificial graphite cells with electrolyte systems according to some embodiments relative to baseline electrolyte systems.

FIG. 4 includes data plots showing the normalized discharge capacity versus cycle time and voltage polarization versus cycle time of cells with various lithium salts and electrolyte systems according to some embodiments relative to baseline electrolyte systems.

FIG. 5 includes data plots showing the normalized discharge capacity versus cycle time and voltage polarization versus cycle time of cells with electrolyte systems with various amounts of DMOHC relative to baseline electrolyte systems.

FIG. 6A is a bar graph showing the charge transfer resistance of lithium iron phosphate cells with electrolyte systems according to some embodiments relative to baseline electrolyte systems.

FIG. 6B is a bar graph showing the voltage polarization of lithium iron phosphate cells with electrolyte systems according to some embodiments relative to baseline electrolyte systems.

FIG. 6C is a bar graph showing the gas formation of lithium iron phosphate cells with electrolyte systems according to some embodiments relative to baseline electrolyte systems.

FIG. 7 is a data plot showing the average parasitic heat flow versus cycle number of lithium iron phosphate cells with electrolyte systems according to some embodiments relative to baseline electrolyte systems.

FIG. 8 is a data plot showing the normalized discharge capacity versus cycle time of lithium iron phosphate cells with electrolyte systems according to some embodiments relative to baseline electrolyte systems.

FIG. 9 is a data plot showing the normalized discharge capacity versus cycle time of LFP/Pure Graphite cells with electrolyte systems according to some embodiments relative to baseline electrolyte systems.

FIG. 10 is a data plot showing the normalized discharge capacity versus cycle time of NMC532/artificial graphite (i.e., “AML”) with electrolyte systems according to some embodiments relative to baseline electrolyte systems.

FIG. 11 is a data plot showing the normalized discharge capacity versus cycle time of LFP/Pure Graphite cells with electrolyte systems according to some embodiments relative to baseline electrolyte systems.

FIG. 12 is a data plot showing the normalized discharge capacity versus cycle time of LFP/Pure Graphite cells with electrolyte systems according to some embodiments relative to baseline electrolyte systems.

FIG. 13A is a data plot showing the normalized discharge capacity versus cycle time of NMC532/artificial graphite (i.e., “AML”) cells at 70° C. with electrolyte systems according to some embodiments relative to baseline electrolyte systems.

FIG. 13B is a data plot showing the voltage polarization versus cycle time of NMC532/artificial graphite (i.e., “AML”) cells at 70° C. with electrolyte systems according to some embodiments relative to baseline electrolyte systems.

FIG. 14 is a data plot showing the charge and discharge capacity versus cycle time of NMC532/artificial graphite cells at 70° C. with electrolyte systems according to some embodiments.

FIG. 15 is a data plot showing the normalized discharge capacity versus cycle time of NMC532/artificial graphite (i.e., AML) cells at 70° C. with electrolyte systems according to some embodiments.

FIG. 16 includes data plots showing the normalized discharge capacity versus cycle time and voltage polarization versus cycle time of lithium iron phosphate cells, at 85° C. with electrolyte systems according to some embodiments relative to baseline electrolyte systems.

FIG. 17 includes data plots showing the normalized discharge capacity versus cycle time and voltage polarization versus cycle time of NMC532/artificial graphite (i.e., “AML”) cells at 85° C. with electrolyte systems according to some embodiments relative to baseline electrolyte systems.

FIG. 18 includes data plots showing the normalized discharge capacity versus cycle time and voltage polarization versus cycle time of Ni83/PG cells at 85° C. with electrolyte systems according to some embodiments relative to baseline electrolyte systems.

FIG. 19 includes data plots showing the discharge capacity versus cycle time and normalized discharge capacity versus cycle time of Ni83/PG cells at 85° C. with electrolyte systems according to some embodiments.

FIG. 20A includes data plots showing the discharge capacity versus cycle time and normalized discharge capacity versus cycle time of Ni83/PG cells at 20° C. with electrolyte systems according to some embodiments.

FIG. 20B includes data plots showing the discharge capacity versus cycle time and normalized discharge capacity versus cycle time of Ni83/PG cells at 85° C. with electrolyte systems according to some embodiments.

FIG. 21A includes data plots showing the discharge capacity versus cycle time and normalized discharge capacity versus cycle time of NMC640/PG cells at 20° C. with electrolyte systems according to some embodiments.

FIG. 21B includes data plots showing the discharge capacity versus cycle time and normalized discharge capacity versus cycle time of NMC640/PG cells at 85° C. with electrolyte systems according to some embodiments.

FIG. 22A includes data plots showing the discharge capacity versus cycle time and normalized discharge capacity versus cycle time of Ni83/PG cells at 85° C. with electrolyte systems according to some embodiments relative to baseline electrolyte systems.

FIG. 22B includes data plots showing the discharge capacity versus cycle time and normalized discharge capacity versus cycle time of Ni83/PG cells at 85° C. with electrolyte systems according to some embodiments relative to baseline electrolyte systems.

### DETAILED DESCRIPTION

Electrolyte formulations comprising solvents that improve lifetimes and/or energy densities of energy storage devices (e.g., lithium ion batteries and/or sodium ion batteries) at elevated voltages and/or temperatures are described. Such solvents may interact with an alkali metal salt (e.g., a sodium salt and/or a lithium salt) to improve device performance. Such solvents may interact with lithium salts to improve device performance, such as improving cycling stability at high temperatures (e.g., at least about 70-85° C.). In some embodiments, the energy storage device electrolyte may include a solvent that comprises a compound of Formula (I) (e.g., Formula (Ia) and/or Formula (Ib)), as discussed herein below. In some embodiments, the energy storage device electrolyte may further include a LiFSI lithium salt. In addition, the energy storage device electrolyte may also include dimethylcarbonate (DMC) as a co-solvent.

In some embodiments, the energy storage device disclosed herein has at least 99% retention of initial capacity after 3,000 hours of charge-discharge cycling when operated between 3.0 V and 3.8 V or at least 96% retention when operated between 3.0 and 4.3 V at a temperature of at least 70° C. While the capacity of traditional energy storage devices and batteries quickly deplete at such voltages and high temperatures, it was discovered that the energy storage devices disclosed herein successfully increased retention of their initial capacity relative to comparative energy storage devices without such electrolyte formulations. As such, the electrolyte formulations provided herein demonstrate improved cycling stability at high temperatures in addition to improved capacity retention over the life of the device, with nominal capacity fade.

### Definitions

Whenever a group is described as being “optionally substituted” that group may be unsubstituted or substituted with one or more of the indicated substituents. Likewise, when a group is described as being “unsubstituted or substituted” if substituted, the substituent(s) may be selected from one or more of the indicated substituents. If no substituents are indicated, it is meant that the indicated “optionally substituted” or “substituted” group may be substituted with one or more group(s) individually and independently selected from deuterium (D), halogen, hydroxy, C₁₋₄ alkoxy, C₁₋₈ alkyl, C₃₋₂₀ cycloalkyl, aryl, heteroaryl, heterocyclyl, C₁₋₆ haloalkyl, cyano, C₂₋₈ alkenyl, C₂₋₈ alkynyl, C₃₋₂₀ cycloalkenyl, aryl(alkyl), heteroaryl(alkyl), heterocyclyl(alkyl), acyl, thiocarbonyl, O-carbamyl, N-carbamyl, O-thiocarbamyl, N-thiocarbamyl, C-amido, N-amido, C-thioamido, N-thioamido, S-sulfonamido, N-sulfonamido, C-carboxy, O-carboxy, sulfenyl, sulfinyl, sulfonyl, haloalkoxy, an amino, a mono-substituted amine group and a di-substituted amine group.

As used herein, “Cₐ to C_{b}” in which “a” and “b” are integers refer to the number of carbon atoms in a group. The indicated group can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “a” and “b” are designated, the broadest range described in these definitions is to be assumed.

As used herein, the term “alkyl” refers to a fully saturated aliphatic hydrocarbon group. The alkyl moiety may be branched or straight chain. Examples of branched alkyl groups include, but are not limited to, iso-propyl, sec-butyl, t-butyl and the like. Examples of straight chain alkyl groups include, but are not limited to, methyl, ethyl, n-propyl, n-butyl, n-pentyl, n-hexyl, n-heptyl and the like. The alkyl group may have 1 to 30 carbon atoms (whenever it appears herein, a numerical range such as “1 to 30” refers to each integer in the given range; e.g., “1 to 30 carbon atoms” means that the alkyl group may consist of 1 carbon atom, 2 carbon atoms, 3 carbon atoms, etc., up to and including 30 carbon atoms, although the present definition also covers the occurrence of the term “alkyl” where no numerical range is designated). The alkyl group may also be a medium alkyl having 1 to 12 carbon atoms. The alkyl group could also be a lower alkyl having 1 to 6 carbon atoms. An alkyl group may be substituted or unsubstituted.

The term “alkenyl” used herein refers to a monovalent straight or branched chain radical of from two to thirty carbon atoms containing a carbon double bond(s) including, but not limited to, 1-propenyl, 2-propenyl, 2-methyl-1-propenyl, 1-butenyl, 2-butenyl and the like. An alkenyl group may be unsubstituted or substituted.

The term “alkynyl” used herein refers to a monovalent straight or branched chain radical of from two to thirty carbon atoms containing a carbon triple bond(s) including, but not limited to, 1-propynyl, 1-butynyl, 2-butynyl and the like. An alkynyl group may be unsubstituted or substituted.

The term “carbonyl” used herein refers to C═O (i.e. carbon double bonded to oxygen).

An “alkylene” group refers to a straight-chained —CH₂— tethering groups, forming bonds to connect molecular fragments via their terminal carbon atoms. Examples include but are not limited to methylene (—CH₂—), ethylene (—CH₂CH₂—), propylene (—CH₂CH₂CH₂—), and butylene (—CH₂CH₂CH₂CH₂—). A lower alkylene group can be substituted by replacing one or more hydrogen of the lower alkylene group with a substituent(s) listed under the definition of “substituted.”

The term “halogen atom” or “halogen” as used herein, means any one of the radio-stable atoms of column 7 of the Periodic Table of the Elements, such as, fluorine, chlorine, bromine and iodine.

As used herein, “haloalkyl” refers to an alkyl group in which one or more of the hydrogen atoms are replaced by a halogen (e.g., mono-haloalkyl, di-haloalkyl and tri-haloalkyl). Such groups include but are not limited to, chloromethyl, fluoromethyl, difluoromethyl, trifluoromethyl, 1-chloro-2-fluoromethyl, 2-fluoroisobutyl, —CH₂CF₃, —CH₂CHF₂, —CH₂CH₂F, —CH₂CH₂Cl, and —CH₂CF₂CF₃. A haloalkyl may be substituted or unsubstituted.

As used herein, “haloalkoxy” refers to an alkoxy group in which one or more of the hydrogen atoms are replaced by a halogen (e.g., mono-haloalkoxy, di-haloalkoxy and tri-haloalkoxy). Such groups include but are not limited to, chloromethoxy, fluoromethoxy, difluoromethoxy, trifluoromethoxy and 1-chloro-2-fluoromethoxy, 2-fluoroisobutoxy. A haloalkoxy may be substituted or unsubstituted.

The term “alkali metal” as used herein means any one of the atoms of column 1 of the Periodic Table of the Elements, excluding hydrogen, such as lithium, sodium, potassium, rubidium, cesium and francium.

As used herein, “salt” refers to any material which is formed when a leaving group, or the hydrogen of an acid form, is replaced by a metal or its equivalent and which becomes ionized when dissolved in a solvent (e.g., water or a polar organic solvent) at the appropriate pKa.

### Solvents

In some embodiments, the electrolyte includes a liquid solvent. A solvent as provided herein need not dissolve every component, and need not completely dissolve each component of the electrolyte. In further embodiments, the solvent can include an organic solvent. In some embodiments, a solvent can include one or more functional groups selected from carbonates, dimer carbonates, ethers and/or esters. In some embodiments, the electrolyte includes one solvent. In other embodiments, the electrolyte includes a plurality of solvents. In some embodiments, the solvent can comprise an alkyl decarbonate compound and/or a dimerization compound (e.g., an alkyl didecarbonate compound).

In some embodiments, the solvent can comprise a compound of Formula (I):

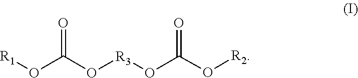

In some embodiments, R₁ and R₂ are each independently an optionally substituted C₁₋₁₂ alkyl. In some embodiments, R₁ is an optionally substituted C₁₋₁₂ alkyl. In some embodiments, R₂ is an optionally substituted C₁₋₁₂ alkyl. For example, in some embodiments, R₁ and R₂ are each independently selected from the group consisting of an optionally substituted methyl, an optionally substituted ethyl, an optionally substituted propyl, an optionally substituted butyl, an optionally substituted iso-propyl, an optionally substituted iso-butyl, and an optionally substituted sec-butyl. In another example, in some embodiments, R₁ and R₂ are each independently selected from the group consisting of methyl and ethyl. In some embodiments, R₁ and R₂ are each independently selected from the group consisting of methyl, ethyl, propyl, iso-propyl, iso-butyl, and sec-butyl. In some embodiments, R₁ and R₂ are each an optionally substituted methyl. In some embodiments, R₁ and R₂ are each methyl. In other embodiments, Rᵢ and R₂ are each an optionally substituted ethyl. In other embodiments, R₁ and R₂ are each ethyl. In some embodiments, R₁ and R₂ are each an optionally substituted propyl. In some embodiments, R₁ and R₂ are each propyl. In some embodiments, R₁ and R₂ are each an optionally substituted butyl. In some embodiments, R₁ and R₂ are each butyl. In some embodiments, Rₜ and R₂ are each an optionally substituted iso-propyl. In some embodiments, R₁ and R₂ are each iso-propyl. In some embodiments, R₁ and R₂ are each an optionally substituted iso-butyl. In some embodiments, R₁ and R₂ are each iso-butyl. In some embodiments, R₁ and R₂ are each an optionally substituted sec-butyl. In some embodiments, R₁ and R₂ are each sec-butyl. In some embodiments, R₁ is an optionally substituted methyl and R₂ is an optionally substituted ethyl. In some embodiments, R₁ is methyl and R₂ are each ethyl. In certain embodiments, the R₁ and R₂ optional substitutions are each independently selected from at least one halogen. In some embodiments, R₁ and R₂ are each a methyl. In other embodiments, R₁ and R₂ are each an ethyl. In some embodiments, R₁ is a methyl and R₂ is an ethyl.

In some embodiments, R₃ is an optionally substituted C₁₋₁₂ alkylene. For example, in some embodiments, R₃ is an optionally substituted ethylene or an optionally substituted propylene. In some embodiments, R₃ is an optionally substituted ethylene. In some embodiments, R₃ is an optionally substituted propylene. In some embodiments, R₃ is (—CH₂CH₂—). In other embodiments, R₃ is (—CH₂CH₂CH₂—). In some embodiments, the R₃ optional substitutions are selected from the group consisting of at least one C₁₋₁₂ alkyl, C₁₋₁₂ haloalkyl, halogen, and combinations thereof.

In some embodiments, the compound is represented by Formula (Ia):

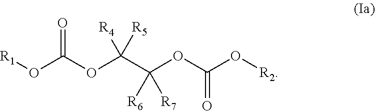

In some embodiments, R₄, R₅, R₆, and R₇ are each independently selected from the group consisting of —H, a halogen, a C₁₋₁₂ alkyl, and a C₁₋₁₂ haloalkyl. In other embodiments, R₄, R₅, R₆, and R₇ are each independently selected from the group consisting of —H, CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃. In certain embodiments, R₄, R₅, R₆, and R₇ are each independently selected from the group consisting of —H, CH₃—, CH₃CH₂—, CH₃CH₂CH(CH₃)—, (CH₃)₃C—, and —CF₃.

In some embodiments, R₄ is selected from the group consisting of —H, a halogen, a C₁₋₁₂ alkyl, and a C₁₋₁₂ haloalkyl. In other embodiments, R₄ is selected from the group consisting of —H. CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃. In certain embodiments, R₄ is selected from the group consisting of —H, CH₃—, CH₃CH₂—, CH₃CH₂CH(CH₃)—, (CH₃)₃C—, and —CF₃.

In some embodiments, R₅ is selected from the group consisting of —H, a halogen, a C₁₋₁₂ alkyl, and a C₁₋₁₂ haloalkyl. In other embodiments. R₅ is selected from the group consisting of —H, CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃. In certain embodiments, R₅ is selected from the group consisting of —H, CH₃—, CH₃CH₂—, CH₃CH₂CH(CH₃)—, (CH₃)₃C—, and —CF₃.

In some embodiments, R₆ is selected from the group consisting of —H, a halogen, a C₁₋₁₂ alkyl, and a C₁₋₁₂ haloalkyl. In other embodiments, R₆ is selected from the group consisting of —H, CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃. In certain embodiments, R₆ is selected from the group consisting of —H, CH₃—, CH₃CH₂—, CH₃CH₂CH(CH₃)—, (CH₃)₃C—, and —CF₃.

In some embodiments, R₇ is selected from the group consisting of —H, a halogen, a C₁₋₁₂ alkyl, and a C₁₋₁₂ haloalkyl. In other embodiments, R₇ is selected from the group consisting of —H, CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃. In certain embodiments, R₇ is selected from the group consisting of —H, CH₃—, CH₃CH₂—, CH₃CH₂CH(CH₃)—, (CH₃)₃C—, and —CF₃.

In some embodiments, the compound is represented by Formula (Ib):

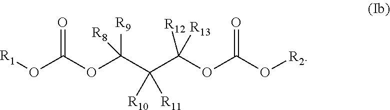

In some embodiments, R₈, R₉, R₁₀, R₁₁, R₁₂, and R₁₃ are each independently selected from the group consisting of —H, a halogen, a C₁₋₁₂ alkyl, and a C₁₋₁₂ haloalkyl. In some embodiments, R₈ is selected from the group consisting of —H, a halogen, a C₁₋₁₂ alkyl, and a C₁₋₁₂ haloalkyl. In some embodiments, R₉ is selected from the group consisting of —H, a halogen, a C₁₋₁₂ alkyl, and a C₁₋₁₂ haloalkyl. In some embodiments, R₁₀ is selected from the group consisting of —H, a halogen, a C₁₋₁₂ alkyl, and a C₁₋₁₂ haloalkyl. In some embodiments, R₁₁ is selected from the group consisting of —H, a halogen, a C₁₋₁₂ alkyl, and a C₁₋₁₂ haloalkyl. In some embodiments, R₁₂ is selected from the group consisting of —H, a halogen, a C₁₋₁₂ alkyl, and a C₁₋₁₂ haloalkyl. In some embodiments, R₁₃ is selected from the group consisting of —H, a halogen, a C₁₋₁₂ alkyl, and a C₁₋₁₂ haloalkyl.

In some embodiments, the compound of Formula (I) may be selected from at least one of the compounds shown in Table 1.

TABLE 1

| Name | Structure |
|---|---|
| dimethyl 2,5-dioxahexanedioate (also “DMOHC” or “ethane-1,2-diyl dimethyl bis(carbonate)”) | 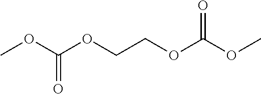 |
| diethyl 2,5-dioxahexanedioate (also “DEOHC” or “ethane-1,2-diyl diethyl bis(carbonate)”) | 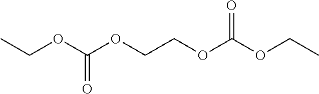 |
| ethyl methyl 2,5-dioxahexanedioate (also “EMOHC” or “ethane-1,2-diyl ethyl methyl bis(carbonate)”) | 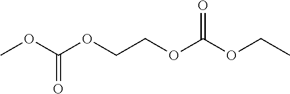 |
| ethane-1,2-diyl methyl (2,2,2-trifluoroethyl) bis(carbonate) | 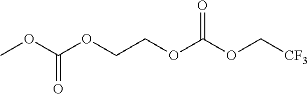 [SMILES: COC(=O)OCCOC(=O)OCC(F)(F)F] |
| ethane-1,2-diyl diisopropyl bis(carbonate) | 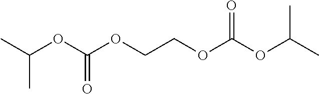 [SMILES: CC(C)OC(=O)OCCOC(=O)OC(C)C] |
| dimethyl propane-1,3-diyl bis(carbonate) | 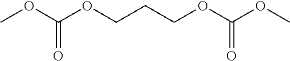 |
| dimethyl propane-1,2-diyl bis(carbonate) (also “Me-DMOHC”) | 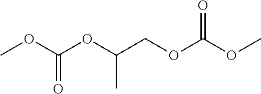 |
| butane-2,3-diyl dimethyl bis(carbonate) (also “DMe-DMOHC” or “DMe”) | 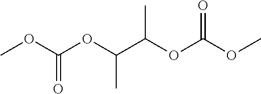 |
| butane-1,2-diyl dimethyl bis(carbonate) (also “Et-DMOHC”) | 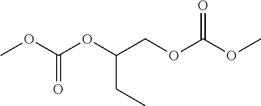 |
| dimethyl (3-methylpentane-1,2-diyl) bis(carbonate) (also “sBu-DMOHC”) | 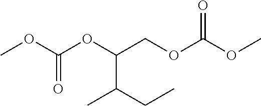 |
| 3,3-dimethylbutane-1,2-diyl dimethyl bis(carbonate) (also “tBu-DMOHC”) | 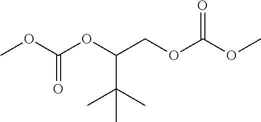 |
| dimethyl (3,3,3-trifluoropropane-1,2-diyl) bis(carbonate) (also “CF3-DMOHC”) | 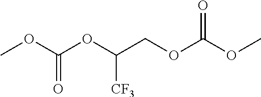 |
| diethyl propane-1,2-diyl bis(carbonate) | 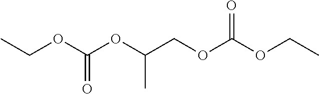 |
| butane-2,3-diyl diethyl bis(carbonate) | 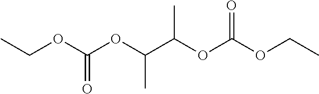 [SMILES: CCOC(=O)OC(C)C(C)OC(=O)OCC] |
| butane-1,2-diyl diethyl bis(carbonate) | 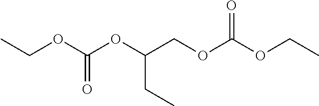 [SMILES: CCOC(=O)OCC(CC)OC(=O)OCC] |
| diethyl (3-methylpentane-1,2-diyl) bis(carbonate) | 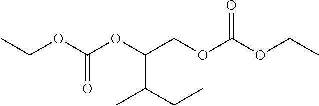 [SMILES: CCOC(=O)OCC(OC(=O)OCC)C(C)CC] |
| 3,3-dimethylbutane-1,2-diyl diethyl bis(carbonate) | 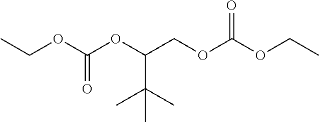 [SMILES: CCOC(=O)OCC(OC(=O)OCC)C(C)(C)C] |
| diethyl (3,3,3-trifluoropropane-1,2-diyl) bis(carbonate) | 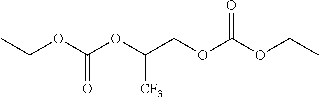 [SMILES: CCOC(=O)OCC(OC(=O)OCC)C(F)(F)F] |
| ethane-1,2-diyl diisobutyl bis(carbonate) | 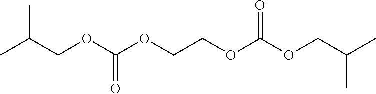 [SMILES: CC(C)COC(=O)OCCOC(=O)OCC(C)C] |
| diisobutyl propane-1,2-diyl bis(carbonate) | 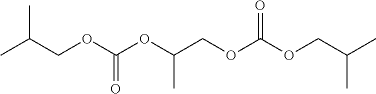 [SMILES: CC(C)COC(=O)OCC(C)OC(=O)OCC(C)C] |
| butane-2,3-diyl diisobutyl bis(carbonate) | 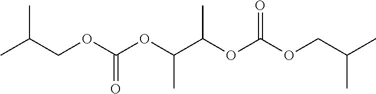 [SMILES: CC(C)COC(=O)OC(C)C(C)OC(=O)OCC(C)C] |
| di-sec-butyl ethane-1,2-diyl bis(carbonate) | 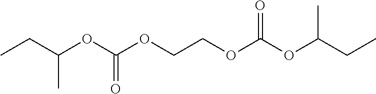 [SMILES: CCC(C)OC(=O)OCCOC(=O)OC(C)CC] |
| di-sec-butyl propane-1,2-diyl bis(carbonate) | 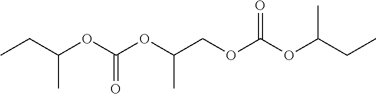 [SMILES: CCC(C)OC(=O)OCC(C)OC(=O)OC(C)CC] |
| butane-2,3-diyl di-sec-butyl bis(carbonate) | 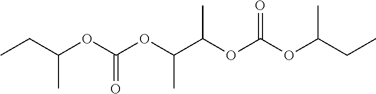 [SMILES: CCC(C)OC(=O)OC(C)C(C)OC(=O)OC(C)CC] |
| isobutyl propane-1,2-diyl propyl bis(carbonate) | 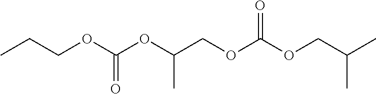 [SMILES: CCCOC(=O)OC(C)COC(=O)OCC(C)C] |
| sec-butyl isobutyl propane-1,2-diyl bis(carbonate) | 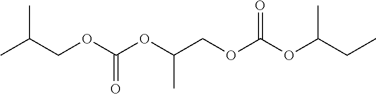 [SMILES: CCC(C)OC(=O)OCC(C)OC(=O)OCC(C)C] |

In some embodiments, the solvent can comprise dimethyl 2,5-dioxahexanedioate (DMOHC). In some embodiments, the solvent can comprise diethyl 2,5-dioxahexanedioate (DEOHC). In some embodiments, the solvent can comprise ethyl methyl 2,5-dioxahexanedioate (EMOHC). In some embodiments, the compound of Formula (I) is selected from the group consisting of

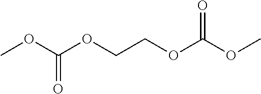

### (DMOHC),

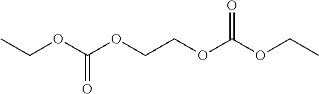

### (DEOHC),

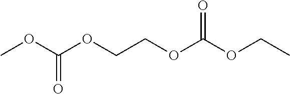

### (EMOHC),

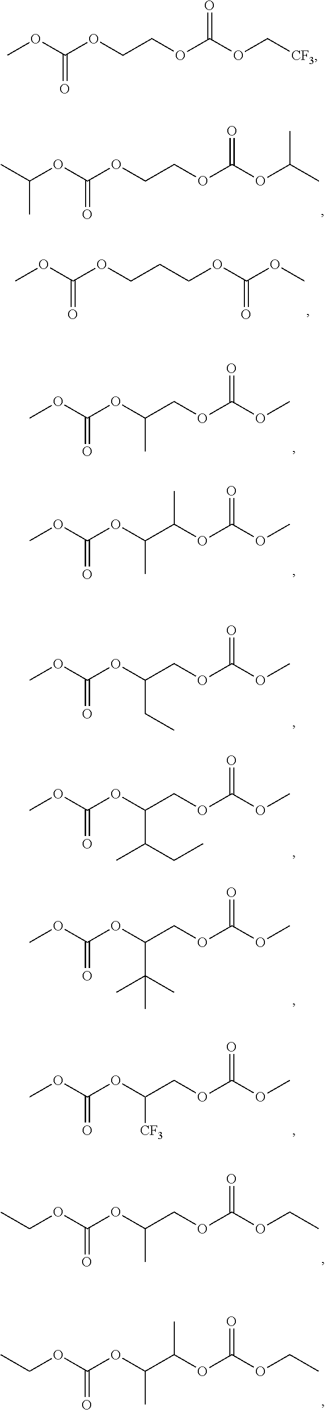

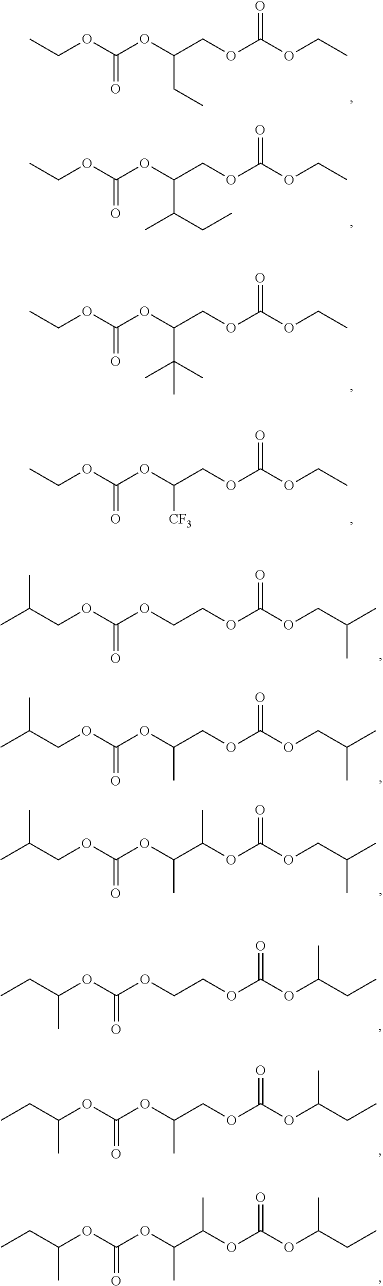

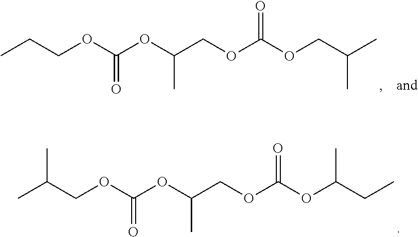

In some embodiments, the compound of Formula (I) is selected from the group consisting of

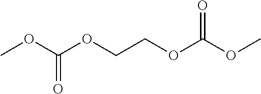

### (DMOHC),

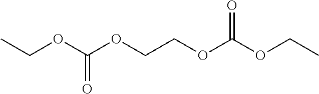

### (DEOHC),

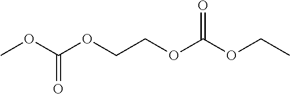

### (EMOHC),

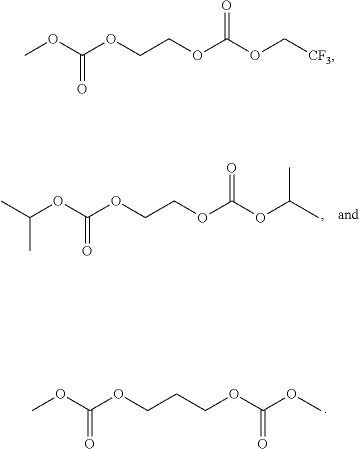

In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. For example, some embodiments, the solvent further comprises DMC. In some embodiments, the solvent further comprises DEC. In some embodiments, the solvent can further comprise methyl acetate (MA). In some embodiments, the solvent can comprise ethyl acetate (EA). In some embodiments, the solvent can comprise propionitrile (PN). In some embodiments, the solvent can comprise acetonitrile (AN). In some embodiments, the solvent can comprise butyrolactone (GBL).

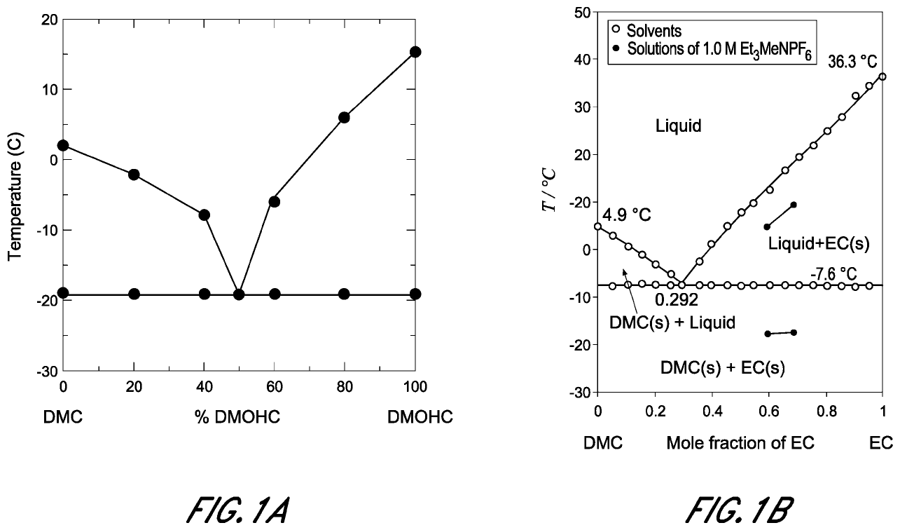

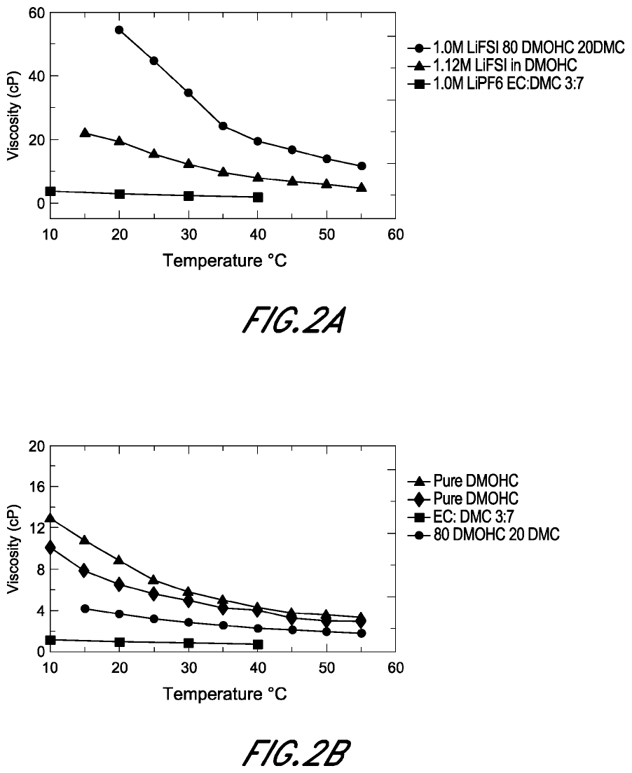

FIG. 1A shows a phase diagram of mixtures of dimethyl carbonate (DMC) and dimethyl 2,5-dioxahexanedioate (DMOHC) and FIG. 1B shows a phase diagram of mixtures of DMC and ethylene carbonate (EC), at various temperatures. As seen in FIGS. 1A and 1B, the phase diagram of mixtures of DMC and DMOHC is relatively similar to the phase diagram of mixtures of DMC and EC. As such, it may be expected that the two solvent systems would be in the liquid phase at similar temperatures.

In some embodiments, the electrolyte comprises the total solvent in, in about, in at least, or in at least about, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %. 94 wt. %, 95 wt. %, 96 wt. %, 97 wt. % or 98 wt. %, or any range of values therebetween. In some embodiments, the electrolyte comprises each solvent individually in, in about, in at least, or in at least about, 80 wt. %, 81 wt. %, 82 wt. %. 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. % or 98 wt. %, or any range of values therebetween.

In some embodiments, the electrolyte comprises one or more solvents. In some embodiments, the electrolyte comprises a 1, 2, 3, 4, 5 or 6 solvent system, or any range of values therebetween. In some embodiments, the electrolyte comprises a first solvent and a second solvent. In some embodiments, the electrolyte solvent system may comprise a first solvent and a second solvent in a volume ratio of about 10:1, 9:1, 8:1, 7:1, 6:1, 5:1, 4:1, 3:1, 2:1, 1:1, 1:2, 1:3, 1:4, 1:4, 1:6, 1:7, 1:8, 1:9, 1:10, or any range therebetween. For example, in some embodiments, the volume ratio can be about 3:7, about 1:1, about 1:4, about 4:1, about 3:2, or about 2:3. In some embodiments, the electrolyte further comprises a second solvent selected from the group consisting of ethylene carbonate (EC), propylene carbonate (PC), vinyl ethylene carbonate (VEC), vinylene carbonate (VC), fluoroethylene carbonate (FEC), dimethyl carbonate (DMC), diethyl carbonate (DEC), ethyl methyl carbonate (EMC), methyl acetate (MA), ethyl acetate (EA), propionitrile (PN), acetonitrile (AN), butyrolactone (GBL), and combinations thereof. For example, in some embodiments, the second solvent comprises dimethyl carbonate (DMC). In other embodiments, the second solvent comprises diethyl carbonate (DEC).

### Electrolytes

The electrolyte formulations described herein can include an alkali metal salt (e.g., a lithium salt and/or a sodium salt) and one or more of the solvents discussed herein. Generally, the alkali metal salt comprises a cation and an anion. In some embodiments, the anion is redox stable. In some embodiments, the anion can be monovalent. In some embodiments, the cation on the alkali metal salt is selected from Li, Na, K and/or Rb. In some embodiments, a sodium salt can be selected from NaPF₆, NaBF₄, NaClO₄, NaN(FSO₂)₂ (NaFSI), NaB(C₂O₄)₂, and combinations thereof. In some embodiments, a lithium salt can be selected from lithium hexafluorophosphate (LiPF₆), lithium tetrafluoroborate (LiBF₄), lithium difluoro(oxalato)borate (LiDFOB), lithium bis(fluorosulfonyl)imide (LiFSI), lithium bis(trifluoromethanesulfonyl)imide (LiTFSI), lithium hexafluoroarsenate(V) (LiAsF₆), lithium perchlorate (LiClO₄), and combinations thereof. In some embodiments, the lithium salt is LiFSI. In some embodiments, the lithium salt can include an anion selected from hexafluorophosphate, tetrafluoroborate, difluoro(oxalato)borate, bis(fluorosulfonyl)imide, bis(trifluoromethanesulfonyl)imide, hexafluoroarsenate(V), and perchlorate. In certain embodiments, the salt concentration of the electrolyte can be, be about, be at most, or be at most about, 0.1 M, 0.2 M, 0.3 M, 0.4 M, 0.5 M, 0.6 M, 0.7 M, 0.8 M. 0.9 M, 1 M, 1.1 M, 1.2 M, 1.3 M, 1.4 M. 1.5 M, 1.6 M, 1.7 M, 1.8 M, 1.9 M, 2 M, 2.1 M, 2.2 M, 2.3 M, 2.4 M, 2.5 M, 2.6 M, 2.7 M, 2.8 M, 2.9 M, 3 M, 3.1 M, 3.2 M, 3.3 M, 3.4 M, 3.5 M, 3.6 M, 3.7 M, 3.8 M, 3.9 M, 4 M, 4.1 M, 4.2 M, 4.3 M, 4.4 M, 4.5 M, 4.6 M, 4.7 M, 4.8 M, 4.9 M, 5 M, 5.1 M, 5.2 M, 5.3 M, 5.4 M, 5.5 M, 5.6 M, 5.7 M, 5.8 M, 5.9 M, 6 M, 6.1 M, 6.2 M, 6.3 M, 6.4 M, 6.5 M, 6.6 M, 6.7 M, 6.8 M, 6.9 M, or 7 M, or any range of values therebetween. For example, in some embodiments, the salt concentration can be about 0.1 M to about 5 M, about 0.2 M to about 3 M, about 0.3 M to about 2 M, or about 0.7 M to about 1.5 M.

In some embodiments, the electrolyte further comprises one or more additional additives. In some embodiments, the additives can be selected from, for example, vinylene carbonate (VC), ethylene sulfate (DTD), lithium difluorophosphate (LFO), fluoroethylene carbonate (FEC), propene sulfone (PES), phenyl trifluoromethyl sulphide (PTS), lithium bis(oxalato)borate (LiBOB), lithium difluoro (oxalate) borate (LiDFOB), triethyl borate (TEB), trimethyl borate (TMB), tris trimethylsilyl borate (TTMSiB), 4-trifluoromethyl benzonitrile (TFMB), tris trimethyl silyl phosphite (TTSPi), tris trimethyl silyl phosphate (TTSPi), triethyl phosphite (TEPi), lithium ethoxide (EthOLi), lithium methoxide (MeOLi), lithium tetrafluoro oxalate phosphate (LiTFOP), lithium difluoro dioxalate phosphate (LiDFDOP), and combinations thereof. In some embodiments, the electrolyte comprises each additive in, in about, in at most, or in at most about, 0.1 wt. %, 0.5 wt. %, 1 wt. %. 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 7 wt. % or 8 wt. %, or any range of values therebetween. In some embodiments, the electrolyte comprises a plurality of additives that total to, to about, to at most, or to at most about, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %. 8 wt. %, 8.5 wt. %, 9 wt. %, 9.5 wt. %, 10 wt. %, 11 wt. % or 12 wt. %, or any range of values therebetween.

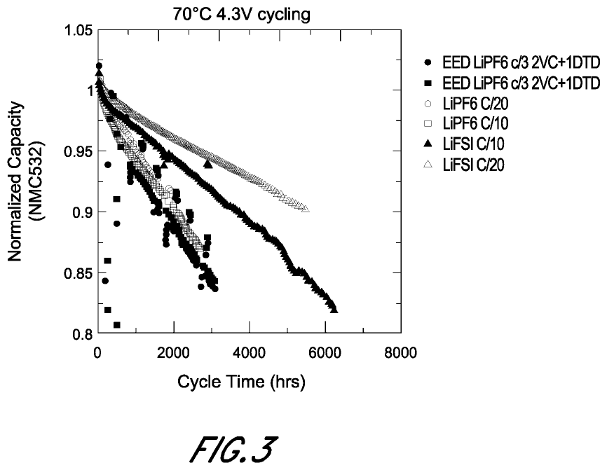

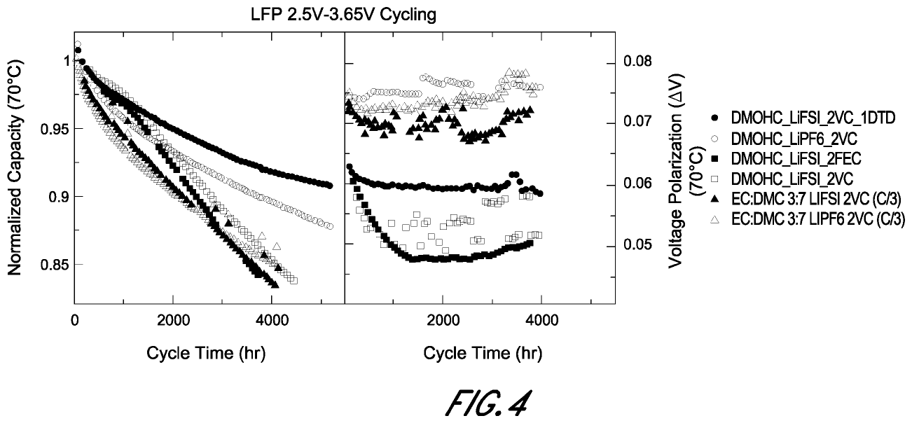

FIGS. 2A and 2B show the viscosity versus temperature of various electrolyte solutions and solvent combinations, including 1.0 M LiFSI in 80:20 DMOHC:DMC; 1.12 M LiFSI in DMOHC; 1.0 M LiPF₆ in 3:7 EC:DMC; pure DMOHC; pure DEOHC; 3:7 EC:DMC; and 80:20 DMOHC:DMC. As seen in FIGS. 2A and 2B, the viscosities of pure DMOHC and DEOHC are greater than those of the 3:7 EC:DMC and 80:20 DMOHC:DMC solvent systems, and the addition of lithium salts generally further increases the viscosities of the electrolyte compositions. In addition, it was observed that LiPF₆ dissolves in DMOHC at room temperature in about five days, and LiFSI dissolves in DMOHC at room temperature at a faster rate relative to that of LiPF₆ (i.e., in less than five days). As such, FIGS. 2A and 2B demonstrate that cells including DMOHC or DEOHC as the sole solvent may require operation at elevated temperatures (e.g., at least about 40° C. or about 40-85° C.) in order to decrease the viscosity and in turn increase ionic conductivity required for the electrolyte. Alternatively, FIGS. 2A and 2B demonstrate that DMOHC and DEOHC may be blended with one or more lower viscosity solvents, for example such as DMC or EC:DMC 30:70, to achieve electrolyte viscosities that may be used in energy storage devices operating at room temperature.

In some embodiments, the viscosity of the electrolyte formulations described herein can be about 1 cP, 2 cP, 3 cP, 4 cP, 5 cP, 6 cP, 7 cP, 8 cP, 9 cP, 10 cP, 11 cP, 12 cP, 13 cP, 14 cP, 15 cP, 16 cP, 17 cP, 18 cP, 19 cP, 20 cP, 21 cP, 22 cP, 23 cP, 24 cP, 25 cP, 26 cP, 27 cP, 28 cP, 29 cP, 30 cP, 31 cP, 32 cP, 33 cP, 34 cP, 35 cP, 36 cP, 37 cP, 38 cP, 39 cP, 40 cP, 40 cP, 41 cP, 42 cP, 43 cP, 44 cP, 45 cP, 46 cP, 47 cP, 48 cP, 49 eP, 50 cP, 51 cP, 52 cP, 53 cP, 54 cP, 55 cP, 56 cP, 57 cP, 58 cP, 59 cP, 60 cP, or any range of values therebetween. For example, about 3 cP to about 8 cP, 8 cP to about 14 cP, 14 cP to about 20 cP, or 20 cP to about 55 cP.

### Energy Storage Device

Energy storage devices of the present disclosure include the electrolyte discussed herein, a cathode, an anode, and a housing, wherein the electrolyte, cathode and anode are disposed within the housing. In some embodiments, an energy storage device as provided herein is a lithium-ion battery and/or a sodium-ion battery. Each of the cathode and anode include an electrode film and a current collected that form the electrode.

In some embodiments, an electrode film as provided herein includes at least one active material. In some embodiments, the electrode film further comprises at least one binder.

In some embodiments, an electrode film includes an anode active material. In some embodiments, anode active materials can include, for example, an insertion material (such as carbon or graphite), an alloying/dealloying material (such as silicon, silicon oxide, tin, and/or tin oxide), a metal alloy or compound (such as Si—Al, and/or Si—Sn), a lithium titanate (LTO), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si-SiOx, Sn-SnOx, Si-SiOx-C, Sn—SnOx-C, Si—Sn—C, SiOx-SnOx-C, Si—SiOx-Sn, or Sn-SiOx-SnOx.). Anode active materials include common natural graphite, synthetic or artificial graphite, surface modified graphite, spherical-shaped graphite, flake-shaped graphite and blends or combinations of these types of graphite, hard carbon, metallic elements and its compound as well as metal-C composite for anode.

In some embodiments, an electrode film includes active cathode material. In some embodiments, cathode active materials can comprise, for example, a metal oxide, metal sulfide, or an alkali metal oxide (e.g., a lithium metal oxide and/or a sodium metal oxide). The lithium metal oxide can be, for example, a lithium nickel manganese cobalt oxide (NMC), a lithium manganese oxide (LMO), a lithium iron phosphate (LFP), a lithium cobalt oxide (LCO), and/or a lithium nickel cobalt aluminum oxide (NCA). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂(NCA)), a spinel manganese oxide (such as LiMn₂O₄ (LMO) and/or LiMn_{1.5}Ni_{0.5}O₄(LMNO)), an olivine (such as LiFePO₄ (LFP), LiMn₁₋ₓFeₓPO₄ (LMFP)). The cathode active material can comprise sulfur or a material including sulfur, such as lithium sulfide (Li₂S), or other sulfur-based materials, or a mixture thereof. In some embodiments, sodium metal oxide can be, for example, a layered oxide, a phosphate, and/or a Ferri cyanide (e.g., a compound of the Prussian white family). In some embodiments, sodium metal oxide can be, for example, NaFe_{0.5}Mn_{0.5}O₂, NaNi_{1/3}Fe_{1/3}Mn_{1/3}O₂, NaFe₂(CN)₆, Na₂VOPO₄F, NaMnO₂, and/or NaFe_{0.3}Mn_{0.5}Cu_{0.2}O₂.

An energy storage device as provided herein can be of any suitable configuration, for example planar, spirally wound, button shaped, or pouch. An energy storage device as provided herein can be a component of a system, for example, a power generation system, an uninterruptible power source systems (UPS), a photo voltaic power generation system, an energy recovery system for use in, for example, industrial machinery and/or transportation. An energy storage device as provided herein may be used to power various electronic device and/or motor vehicles, including hybrid electric vehicles (HEV), plug-in hybrid electric vehicles (PHEV), and/or electric vehicles (EV).

In some embodiments, an energy storage device including an electrolyte formulation as provided herein may demonstrate a higher discharge rate capability relative to comparative energy storage devices. Such higher discharge rate capability is desirable in high energy, high power applications such as electric vehicle propulsion. In some embodiments, an energy storage device including an electrolyte formulation as provided herein may demonstrate improved cycling stability at exceptionally high temperatures (e.g., at least about 70° C. or about 70-85° C.).

An energy storage device including an electrolyte formulation described herein may be characterized by improved capacity retention over the life of the device. Further improvements that may be realized in various embodiments include improved cycling performance, including improved storage stability during cycling and reduced capacity fade. In some embodiments, improved cycling performance were also achieved at exceptionally high temperatures (e.g., at least about 70° C. or about 70-85° C.). In some embodiments, the energy storage device is configured to operate at, at about, at least, or at least about, 20° C., 25° C., 30° C., 35° C., 40° C., 45° C., 50° C., 55° C., 60° C., 65° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 95° C., 100° C., 105° C., or any range of values therebetween. For example, 20° C. to 30° C., 70° C. to 85° C., 20° C. to 85° C., or 50° C. to 85° C. In some embodiments, the energy storage device is configured to operate at, or at about, 2.5 V, 2.6 V, 2.7 V, 2.8 V, 2.9 V, 3 V, 3.1 V, 3.2 V, 3.3 V, 3.4 V, 3.5 V. 3.6 V, 3.7 V, 3.8 V, 3.9 V, 4 V, 4.1 V, 4.2 V, 4.3 V, 4.4 V, or 4.5 V, or any range of values therebetween. For example, 2.5 V to 4.5 V, 3.0 V to 4.2 V, 4.1 V to 4.3 V, 2.5 V to 3.7 V, 3.3 V to 3.4 V, 3.0 V to 4.3 V, or 3 V to 3.8 V. In further embodiments, the lithium ion battery is configured to have a minimum operating voltage of about 2.5 V to about 3 V, respectively. In still further embodiments, the lithium ion battery is configured to have a maximum operating voltage of about 3.8 V to about 4.4 V, respectively.

In some embodiments, after 2,000 hours of cycling at an operating temperature of at least 70° C., the energy storage device has a retention of initial capacity of at least 99%, 98%, 97%, 96%, 95%, 94%, 93%, 92%, 91%, 90%, 89%, 88%, 87%, 86%, 85%, 84%, 83%, 82%, 81%, 80%, or any range of values therebetween. For example, 99% to 90%, 99% to 95%, 98% to 91%, or 90% to 85%.

In some embodiments, the electrolyte formulations described herein may advantageously exhibit improved performance relative to typical electrolyte formulations. The performance may be with regard to, for example, coulombic efficiency, voltage polarization, capacity, and/or conductivity. Voltage polarization is the difference between a cell's average charge and discharge voltage (ΔV). Accordingly, a smaller ΔV value may indicate a smaller polarization in the cell and lower impedance. Consequentially, an increase in the ΔV with cycle number may indicate an impedance increase during cycling. The first charge and discharge of an energy storage device (i.e., the “formation process”) may be performed in a factory by the manufacturer. As such, it may be advantageous to minimize gas generation during the formation process in order to simplify the manufacturing process. Charge transfer resistance is a measure of the difficulty encountered when an electron and a lithium ion are moved into the anode or cathode material as a lithium atom during the operation of the lithium-ion cell. As such, the greater the measurement of the charge transfer resistance, the more energy is lost during the charge transfer.

In some embodiments, an energy storage device as provided herein may have a discharge capacity retention of at least about 99%, 98%, 97%, 96%, 95%, 94%. 93%, 92%, 91%, 90%, 89%, 88%, 87%, 86%, 85%, 84%, 83%, 82%, 81%, 80%, or any range of values therebetween, when cycled between 2.5 V and 4.5 V or between 2.5 V and 4.3 V after at least about 500 hours of cycling at an operating temperature of at least 70° C. In some embodiments, an energy storage device as provided herein may have a discharge capacity retention of at least about 80% when cycled between 2.5 V, 2.6 V, 2.7 V, 2.8 V, 2.9 V, 3 V, 3.1 V, 3.2 V, 3.3 V, 3.4 V, 3.5 V, 3.6 V, 3.7 V, 3.8 V, 3.9 V, 4 V, 4.1 V, 4.2 V, 4.3 V, 4.4 V, or 4.5 V. or any range of values therebetween, after at least about 500 hours of cycling at an operating temperature of at least 70° C. In some embodiments, an energy storage device as provided herein may have a discharge capacity retention of at least about 80% when cycled between 2.5 V and 4.5 V after at least 500 hours, 600 hours, 700 hours, 800 hours, 900 hours, 1,000 hours, 1,100 hours, 1,200 hours, 1,300 hours, 1,400 hours, 1,500 hours, 1,600 hours, 1,700 hours, 1,800 hours, 1,900 hours, 2,000 hours, 2,100 hours, 2,200 hours, 2,300 hours, 2,400 hours, 2,500 hours, 2,600 hours, 2,700 hours, 2,800 hours, 2,900 hours, 3,000 hour, 3,500 hours, 4,000 hours, 4,500 hours, 5,000 hours, or any range of values therebetween, at an operating temperature of at least 70° C. In some embodiments, an energy storage device as provided herein may have a discharge capacity retention of at least 80% when cycled between 2.5 V and 4.5 V after at least about 500 hours of cycling at an operating temperature of at least 20° C., 25° C., 30° C., 35° C., 40° C., 45° C., 50° C., 55° C., 60° C., 65° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 95° C., 100° C., 105° C., or any range of values therebetween.

It will be understood that an electrolyte formulation provided herein, can be used in various embodiments with any of a number of energy storage devices and systems, such as one or more batteries, capacitors, capacitor-battery hybrids, fuel cells, or other energy storage systems or devices and combinations thereof. In some embodiments, an electrolyte additive or electrolyte including an additive described herein may be implemented in lithium ion batteries and/or sodium ion batteries.

### Methods of Preparing

Some embodiments of the present disclosure relate to a method for preparing the energy storage device disclosed herein. In some embodiments, a method of preparing an energy storage device includes: disposing a cathode, an anode, a separator disposed between the cathode and the anode, and an electrolyte within a housing. In some embodiments, the electrolyte comprises a solvent and an alkali metal salt. The solvent comprises a compound represented by Formula (I) as described herein.

### EXAMPLES

Example embodiments of the present disclosure, including processes, materials and/or resultant products, are described in the following examples.

### Example 1—Initial Cycling Matrix

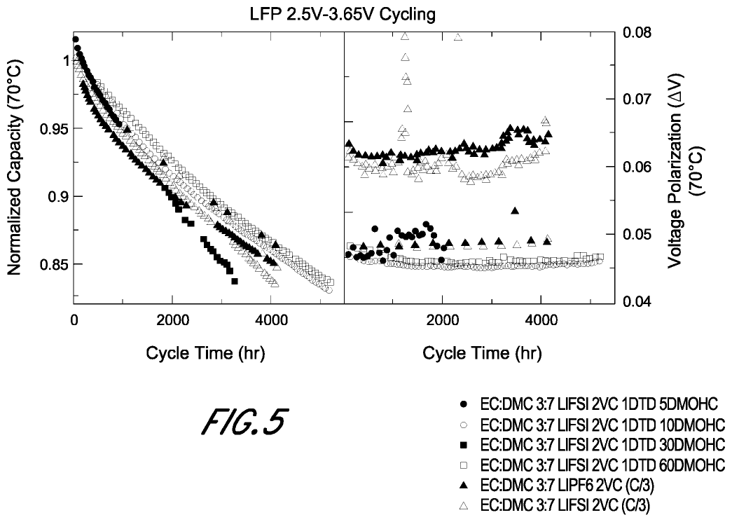

As can be seen in FIG. 3, compared to standard electrolyte systems using 25:5:70 EC:EMC:DMC (i.e., “EED”) as the solvent system, cells utilizing dimethyl 2,5-dioxahexanedioate (DMOHC) as the sole solvent with 2% vinylene carbonate (VC) as an additive afforded impressive results. As an initial cycling matrix, the normalized discharge capacity versus cycle time of NMC532/artificial graphite cells was tested. FIG. 3 shows the normalized discharge capacity versus cycle time of NMC532/artificial graphite cells with various lithium salts and additives tested at an operating temperature of 70° C. and an operating voltage of 4.3 V, including:
(a) LiPF₆ in 25:5:70 EC:EMC:DMC, with 2% vinylene carbonate (VC) and 1% ethylene sulfate (DTD), cycled at a continuous 3-hour charge and discharge protocol (C/3) with a 20 hour charge and discharge cycle every 50 cycles (two instances of “EED LiPF₆ c/3 2VC+1DTD”) (i.e., “control”);
(b) LiPF₆ in pure dimethyl 2,5-dioxahexanedioate (DMOHC), with 2% VC, cycled at a continuous 20-hour charge and discharge protocol (C/20) (“LiPF6 C/20”);
(c) LiPF₆ in pure DMOHC, with 2% VC, cycled at a continuous 10-hour charge and discharge protocol (C/10) (“LiPF6 C/10”);
(d) LiFSI in pure DMOHC, with 2% VC, and C/10 cycling (“LiFSI C/10”); and
(e) LiFSI in pure DMOHC, with 2% VC, and C/20 cycling (“LiFSI C/20”).

As seen in FIG. 3, the normalized discharge capacity versus cycle time of cells with LiFSI in pure DMOHC provided exceptional capacity retentions compared to control electrolytes during C/10 and C/20. For example, the normalized capacity of cells with DMOHC and LiFSI after 6,000 cycle hours was about 90%, while the normalized capacity of standard electrolyte systems using 25:5:75 EC:EMC:DMC as the solvent reached the same capacity after about 2,000 cycle hours.

### Example 2—LFP/PG Cells with DMOHC and Mixed Blends

As can be seen in FIG. 4, lithium iron phosphate (i.e., “LFP”) cells utilizing Pure Graphite (i.e., “PG”) as the negative electrode operating at 70° C. with LiFSI, 2% VC, and 1% DTD shows the greatest C/20 capacity retention. LFP/PG cells with DMOHC and mixed blends were tested at 70° C. and C/20 cycling. FIG. 4 shows the normalized discharge capacity versus cycle time and voltage polarization versus cycle time of LFP/PG cells with various lithium salts and additives including:
(a) LiFSI in pure DMOHC, with 2% VC and 1% DTD, and C/20 cycling (“DMOHC_LiFSI_2VC_1DTD”);
(b) LiPF₆ in pure DMOHC, with 2% VC, and C/20 cycling (“DMOHC_LiPF6_2VC”);
(c) LiFSI in pure DMOHC, with 2% fluoroethylene carbonate (FEC), and C/20 cycling (“DMOHC_LiFSI_2FEC”);
(d) LiFSI in pure DMOHC, with 2% VC, and C/20 cycling (“DMOHC_LiFSI_2VC”);
(e) LiFSI in 3:7 EC:DMC, with 2% VC, and C/3 cycling (“EC:DMC 3:7 LIFSI 2VC (C/3)”) (i.e., “control 1”); and
(f) LiPF₆ in 3:7 EC:DMC, with 2% VC, and C/3 cycling (“EC:DMC 3:7 LIPF6 2VC (C/3)”) (i.e., “control 2”).

FIG. 5 shows the normalized discharge capacity versus cycle time and voltage polarization versus cycle time of LFP/PG cells with electrolyte systems with various amounts of DMOHC including:
(a) LiFSI in 5% by volume DMOHC and 95% by volume 3:7 EC:DMC, with 2% VC and 1% DTD, and C/20 cycling (“EC:DMC 3:7 LIFSI 2VC iDTD 5DMOHC”);
(b) LiFSI in 10% by volume DMOHC and 90% by volume 3:7 EC:DMC, with 2% VC and 1% DTD, and C/20 cycling (“EC:DMC 3:7 LIFSI 2VC 1DTD 10DMOHC”);
(c) LiFSI in 30% by volume DMOHC and 70% by volume 3:7 EC:DMC, with 2% VC and 1% DTD, and C/20 cycling (“EC:OMC 3:7 LIFSI 2VC iDTD 30DMOHC”);
(d) LiFSI in 60% by volume DMOHC and 40% by volume 3:7 EC:DMC, with 2% VC and 1% DTD, and C/20 cycling (“EC:DMC 3:7 LIFSI 2VC IDTD 60DMOHC”); and
(e) LiPF₆ in 3:7 EC:DMC, with 2% VC, and C/3 cycling (“EC:DMC 3:7 LIPF6 2VC (C/3)”) (i.e., “control 2”); and
(f) LiFSI in 3:7 EC:DMC, with 2% VC, and C/3 cycling (“EC:DMC 3:7 LIFSI 2VC (C/3)”) (i.e., “control 1”).

As seen in FIG. 4. cells having electrolytes with pure DMOHC and further including the additive VC or 2% VC+1% DTD provided the relatively best capacity retention. In addition, cells having electrolytes with a 60:40 blend of DMOHC and EC:DMC provided the relatively best capacity retention, as demonstrated in FIG. 5. The control electrolytes 1 and 2 with co-solvents EC:DMC 3:7 alone led to inferior capacity retention.

### Example 3—Post Formation Metrics of Cells Containing DMOHC and DEOHC

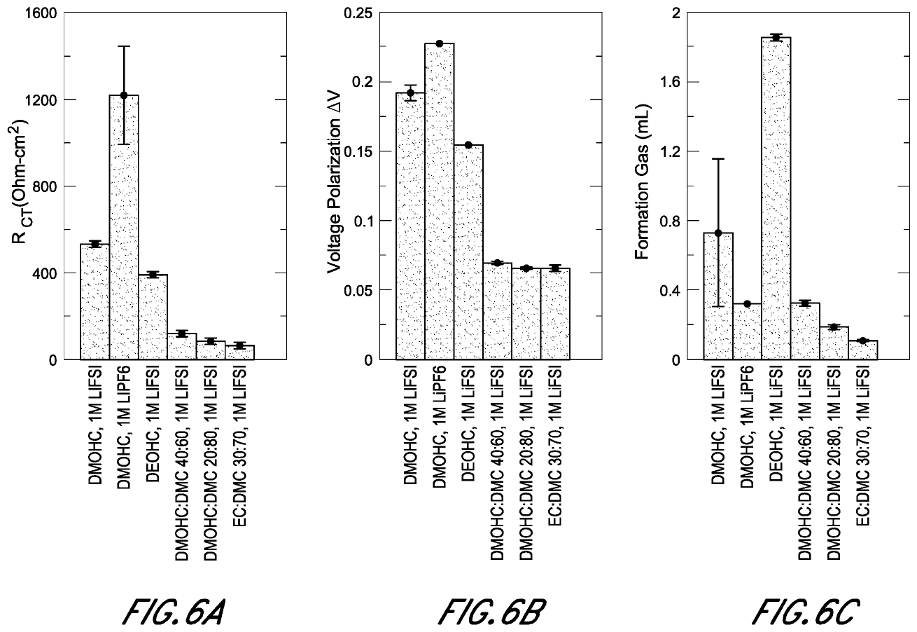

As can be seen in FIGS. 6A-6C, blending DMOHC with DMC in lithium iron phosphate cells lowered impedance (R_{ct} and ΔV), and lowered gas generation after the formation process conducted at 40° C. and C/20. FIGS. 6A-6C show the impedance and gas generation data of electrolyte formulations including:
(a) 1 M LiFSI in pure DMOHC with 2% VC+1% DTD (“DMOHC, 1M LIFSI”);
(b) 1 M LiPF₆ in pure DMOHC with 2% VC+1% DTD (“DMOHC, 1M LiPF₆”);
(c) 1 M LiFSI in pure diethyl 2,5-dioxahexanedioate (DEOHC) with 2% VC+1% DTD (“DEOHC. 1M LiFSI”);
(d) 1 M LiFSI in 40:60 DMOHC:DMC with 2% VC+1% DTD (“DMOHC:DMC 40:60, 1M LiFSI”);
(e) 1 M LiFSI in 20:80 DMOHC:DMC with 2% VC+1% DTD (“DMOHC:DMC 20:80, 1M LiFSI”); and
(f) 1 M LiFSI in 30:70 EC:DMC with 2% VC+1% DTD (“EC:DMC 30:70, 1M LiFSI”).

As seen in FIGS. 6A and 6B, the charge transfer resistance of lithium iron phosphate cells with 60% DMC provided improved results and lowered impedance when compared to cells with pure DMOHC or pure DEOHC. Similarly, lithium iron phosphate cells with LiFSI in 60% DMC and 40% DMOHC formed less gas than lithium iron phosphate cells with LiFSI in pure DMOHC. FIG. 6C shows that cells with LiPF₆ in pure DMOHC provided improved results in regard to gas generation when compared to cells with LiFSI in pure DMOHC. In addition, cells with at least 60% DMC provided improved gas generation results when compared to cells with pure DMOHC or pure DEOHC.

### Example 4—Microcalorimetry and Parasitic Heat Flow on LFP Cells

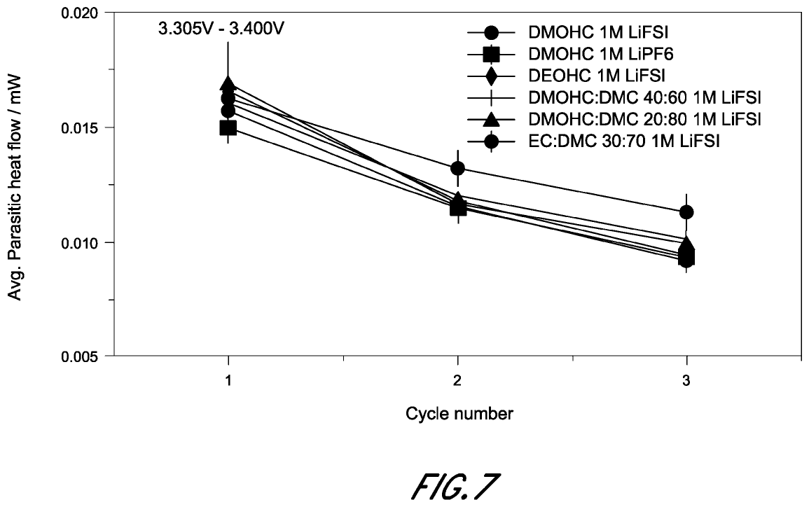

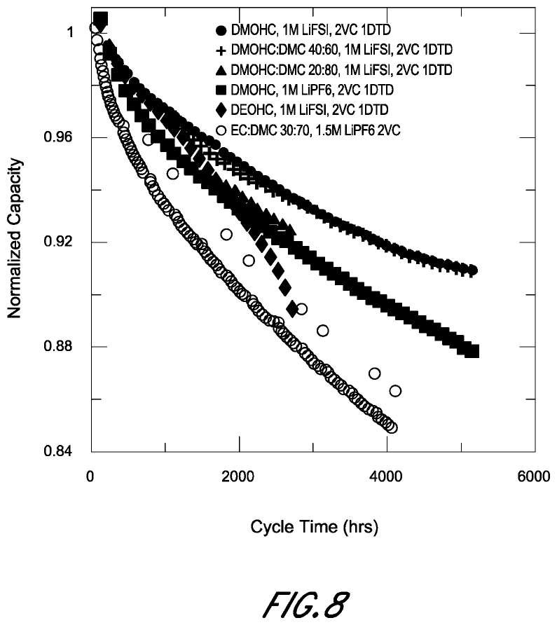

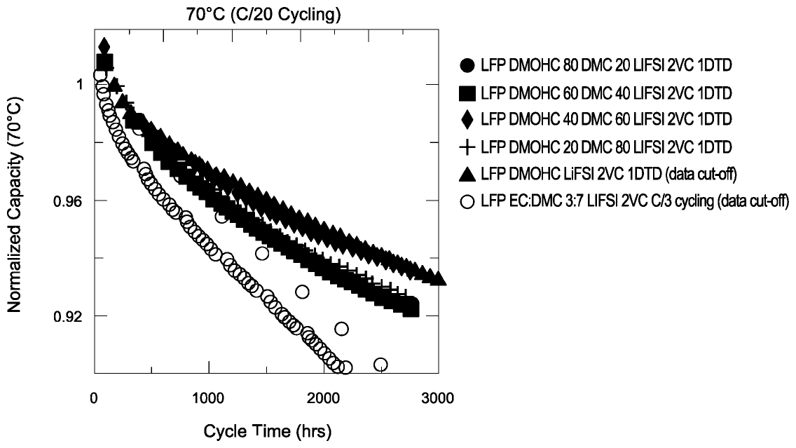

FIG. 7 shows the average parasitic heat flow versus cycle number of LFP/PG cells utilizing the same electrolyte formulations as FIGS. 6A-6C. As seen in FIG. 7, the lowest parasitic heat flow in microcalorimetry experiments matched the best cycle life for pure DMOHC cells as seen in FIG. 4. Mixed blends of solvents provided improved parasitic heat flow results over the control electrolytes including 30:70 EC:DMC. As such, blending 20%-40% DMOHC with DMC provided the best compromise between formation performance and cycling performance.

### Example 5—Normalized Discharge Capacity in LFP Cells with DMOHC and Mixed Blends

FIG. 8 shows the normalized discharge capacity versus cycle time of LFP/PG cells tested at an operating temperature of 70° C., including:
(a) 1 M LiFSI in pure DMOHC, with 2% VC and 1% DTD (“DMOHC, 1M LiFSI, 2VC 1DTD”);
(b) 1 M LiFSI in 40:60 DMOHC:DMC, with 2% VC and 1% DTD (“DMOHC:DMC 40:60, 1M LiFSI, 2VC 1DTD”);
(c) 1 M LiFSI in 20:80 DMOHC:DMC, with 2% VC and 1% DTD (“DMOHC:DMC 20:80, 1M LiFSI, 2VC 1DTD”);
(d) 1 M LiPF₆ in pure DMOHC, with 2% VC and 1% DTD (“DMOHC, 1M LiPF6, 2VC 1DTD”);
(e) 1 M LiFSI in pure DEOHC, with 2% VC and 1% DTD (“DEOHC, 1M LIFSI, 2VC iDTD”); and
(f) 1.5 M LiPF₆ in 30:70 EC:DMC, with 2% VC (“EC:DMC 30:70, 1.5M LiPF6, 2VC”) (i.e., “control”).

As seen in FIG. 8, cells comprising DMOHC and 20% or 40% DMC provided improved capacity retention compared to the control. Cells comprising pure DMOHC or DEOHC also provided improved capacity results compared to the control. For example, the normalized discharge capacity of lithium iron phosphate cells with pure DMOHC after 3,750 cycle hours was over 92%, while the normalized capacity of the control electrolyte systems was about 86% after 3,750 cycle hours. As such, all the cells with DMOHC or DEOHC provided improved capacity retention relative to the control electrolyte systems.

### Example 6—Capacity Retention in LFP/PG Cells with DMOHC and Mixed Blends

As can be seen in FIG. 9, blending DMOHC with DMC yields improved capacity retention compared to control electrolyte. FIG. 9 shows the normalized discharge capacity versus cycle time of LFP/PG cells tested at an operating temperature of 70° C., including:
(a) LiFSI in 80:20 DMOHC:DMC, with 2% VC and 1% DTD, and C/20 cycling (“LFP DMOHC 80 DMC 20 LIFSI 2VC 1DTD”);
(b) LiFSI in 60:40 DMOHC:DMC, with 2% VC and 1% DTD, and C/20 cycling (“LFP DMOHC 60 DMC 40 LIFSI 2VC 1DTD”);
(c) LiFSI in 40:60 DMOHC:DMC, with 2% VC and 1% DTD, and C/20 cycling (“LFP DMOHC 40 DMC 60 LIFSI 2VC 1DTD”);
(d) LiFSI in 20:80 DMOHC:DMC, with 2% VC and 1% DTD, and C/20 cycling (“LFP DMOHC 20 DMC 80 LIFSI 2VC 1DTD”);
(e) LiFSI in pure DMOHC, with 2% VC and 1% DTD, and C/20 cycling (“LFP DMOHC LiFSI 2VC 1DTD (data cut-off)”); and
(f) LiFSI in 3:7 EC:DMC, with 2% VC, and C/3 cycling (“LFP EC:DMC 3:7 LIFSI 2VC C/3 cycling (data cut-off)”) (i.e., “control”).

FIG. 9 demonstrates the performance benefits of cells with electrolyte systems comprising DMOHC and at least 20% DMC compared to the control electrolyte systems. Cells comprising 40% DMOHC and 60% DMC provided the best cycling performance out of the mixed DMOHC/DMC electrolyte systems. Cells with 100% DMOHC provided the best cycling results relative to the mixed DMOHC/DMC electrolyte systems and control.

### Example 6—Cycling Matrix with DEOHC

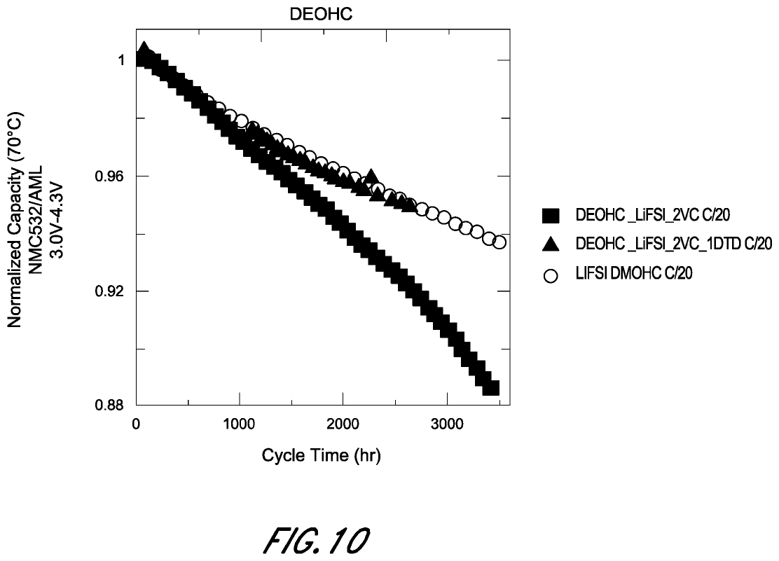

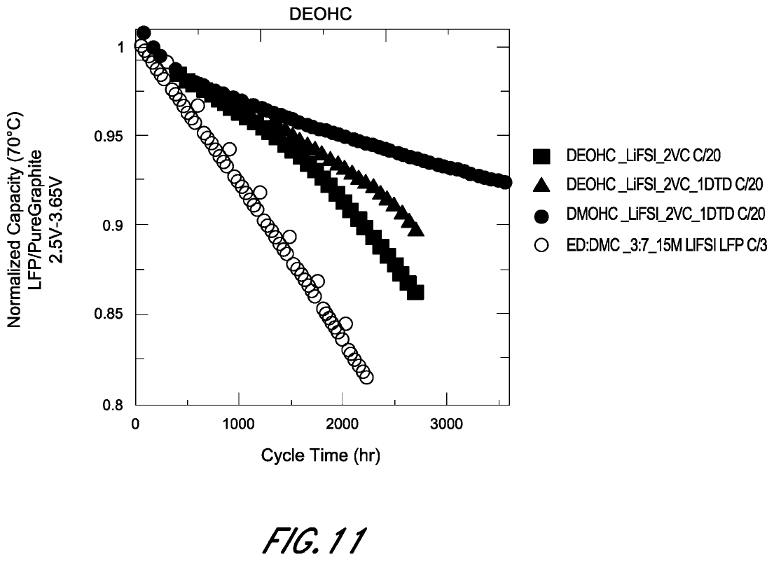

FIG. 10 shows the normalized discharge capacity versus cycle time of NMC532/artificial graphite (i.e., “AML”) cells tested between 3.0 and 4.3 V at an operating temperature of 70° C., including:
(a) LiFSI in DEOHC, with 2% VC, and C/20 cycling between 3.0 V to 4.3 V (“DEOHC_LiFSI_2VC C/20”);
(b) LiFSI in DEOHC, with 2% VC and 1% DTD, and C/20 cycling between 3.0 V to 4.3 V (“DEOHC_LiFSI_2VC_1DTD C/20”); and
(c) LiFSI in DMOHC, with 2% VC and C/20 cycling between 3.0 V to 4.3 V (“LIFSI DMOHC C/20”).

FIG. 11 shows the normalized discharge capacity versus cycle time of LFP/PG cells tested at an operating temperature of 70° C., including:
(a) LiFSI in DEOHC, with 2% VC, and C/20 cycling between 2.5 V to 3.65 V (“DEOHC_LiFS1_2VC C/20”);
(b) LiFSI in DEOHC, with 2% VC and 1% DTD, and C/20 cycling between 2.5 V to 3.65 V (“DEOHC_LiFSl_2VC iDTD C/20”);
(c) LiFSI in DMOHC, with 2% VC and 1% DTD, and C/20 cycling between 2.5 V to 3.65 V (“DMOHC_LiFSl_2VC_iDTD C/20”); and
(d) LiFSI in 3:7 EC:DMC, with 2% VC and C/3 cycling between 2.5 V to 3.65 V (“EC:DMC_3:7_15M LIFSI LFP C/3”) (i.e., “control”).

As seen in FIG. 10, NMC532/artificial graphite cells with DMOHC and DEOHC show similar capacity retention performance. In cells utilizing LFP/PG, cells with DMOHC performed better relative to cells comprising using DEOHC, and the control, as demonstrated in FIG. 11. LFP/PG cells with DEOHC showed improved results over control cells.

### Example 8—Capacity Retention in LFP/PG Cells Operated with DEOHC and DMC

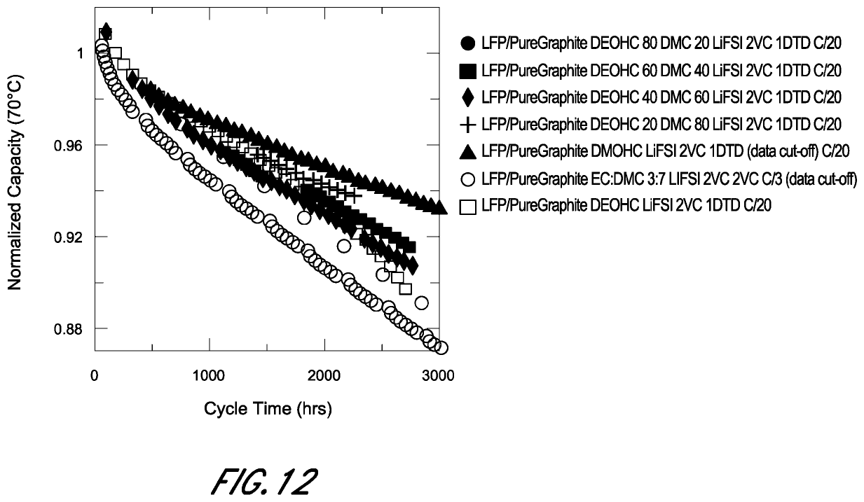

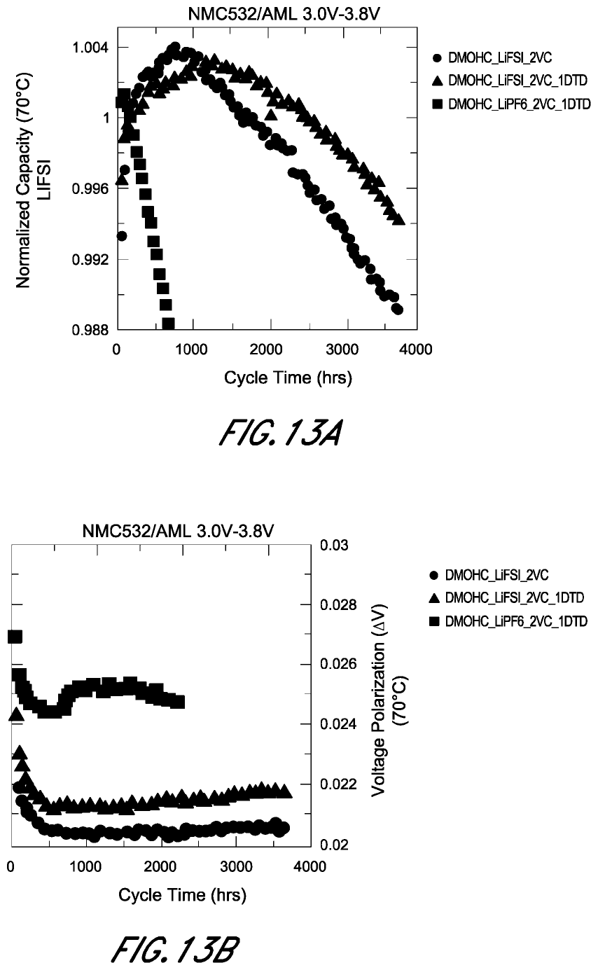

FIG. 12 shows the normalized discharge capacity versus cycle time of LFP cells tested at an operating temperature of 70° C., including:
(a) LiFSI in 80:20 DEOHC:DMC, with 2% VC and 1% DTD, and C/20 cycling (“LFP/PureGraphite DEOHC 80 DMC 20 LiFSI 2VC IDTD C/20”);
(b) LiFSI in 60:40 DEOHC:DMC, with 2% VC and 1% DTD, and C/20 cycling (“LFP/PureGraphite DEOHC 60 DMC 40 LiFSI 2VC 1DTD C/20”);
(c) LiFSI in 40:60 DEOHC:DMC, with 2% VC and 1% DTD, and C/20 cycling (“LFP/PureGraphite DEOHC 40 DMC 60 LiFSI 2VC 1DTD C/20”);
(d) LiFSI in 20:80 DEOHC:DMC, with 2% VC and 1% DTD, and C/20 cycling (“LFP/PureGraphite DEOHC 20 DMC 80 LiFSI 2VC 1DTD C/20”);
(e) LiFSI in pure DMOHC, with 2% VC and 1% DTD, and C/20 cycling (“LFP/PureGraphite DMOHC LiFSI 2VC 1DTD (data cut-off) C/20”);
(f) LiFSI in 3:7 EC:DMC, with 2% VC, and C/3 cycling (“LFP/PureGraphite EC:DMC 3:7 LIFSI 2VC C/3 cycling (data cut-off)”) (i.e., “control”); and
(g) LiFSI in pure DEOHC, with 2% VC and 1% DTD, and C/20 cycling (“LFP/PureGraphite DEOHC LiFSI 2VC 1DTD C/20”).

As seen in FIG. 12, the normalized discharge capacity of lithium iron phosphate cells with DEOHC:DMC mixtures after 2,000 cycle hours at 70° C. was over 93%. Similar results were observed with lithium iron phosphate cells utilizing pure DMOHC after 2,000 cycle hours. In contrast, the normalized capacity of the control electrolyte systems utilizing EC:DMC 3:7 was only about 91% after 2,000 cycle hours at 70° C.

### Example 9—NMC532/Artificial Graphite Cells Balanced to 3.8 V with DMOHC

As can be seen in FIGS. 13A and 13B, cells with electrolyte systems comprising DMOHC and LiFSI with 2% VC and 1% DTD showed incredible capacity retention when tested at 70° C. FIG. 13A shows the normalized discharge capacity versus cycle time and FIG. 13B shows the voltage polarization versus cycle time of NMC532/artificial graphite (i.e., “AML”) cells balanced to 3.8 V including:
(a) LiFSI in pure DMOHC, with 2% VC (“DMOHC_LiFSI_2VC”);
(b) LiFSI in pure DMOHC, with 2% VC and 1% DTD (“DMOHC_LiFSI_2VC_1DTD”); and
(c) LiPF₆ in pure DMOHC, with 2% VC and 1% DTD (“DMOHC_LiPF6_2VC_1DTD”).

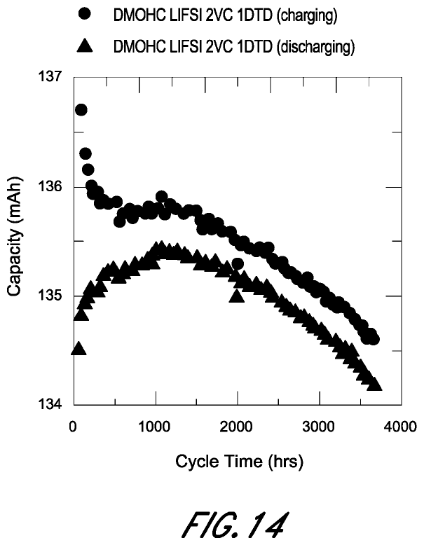

FIG. 14 shows the charge and discharge capacity versus cycle time of an NMC532/artificial graphite cell tested at an operating temperature of 70° C. including LiFSI in pure DMOHC, with 2% VC and I % DTD (“DMOHC LIFSI 2VC 1DTD (charging)” and “DMOHC LIFSI 2VC 1DTD (discharging),” respectively).

As seen in FIG. 13A, the normalized capacity of NMC532/artificial graphite cells with DMOHC and LiFSI after about 3,500 cycle hours was about 99%. Moreover, minimal voltage polarization increases with testing time were observed in NMC532/artificial graphite cells including LiFSI in pure DMOHC, with 2% VC and NMC532/artificial graphite cells with LiFSI in pure DMOHC, with 2% VC and 1% DTD, as seen in FIG. 13B. Moreover, minimal differences between charge and discharge capacity were also observed in NMC532/artificial graphite cells with LiFSI in pure DMOHC, with 2% VC and 1% DTD, as seen in FIG. 14. This represents a coulombic efficiency of about 99.8% for charge discharge cycles that take 40 hours at a temperature of 70° C.

### Example 10—NMC532/Artificial Graphite Cells Balanced to 3.8 V with DMOHC

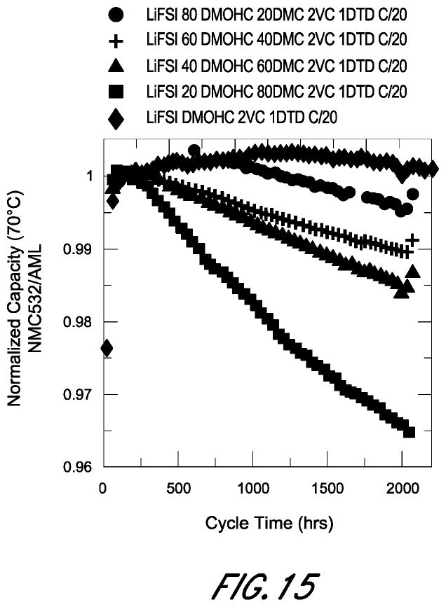

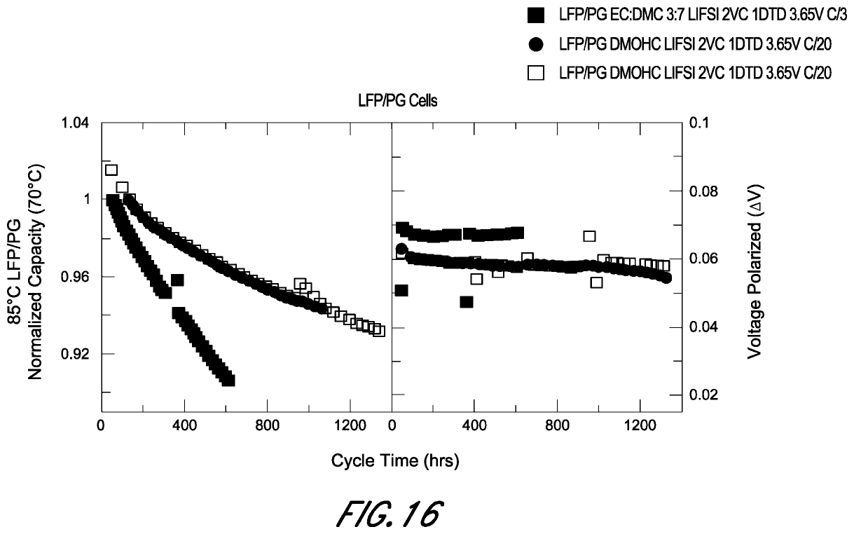

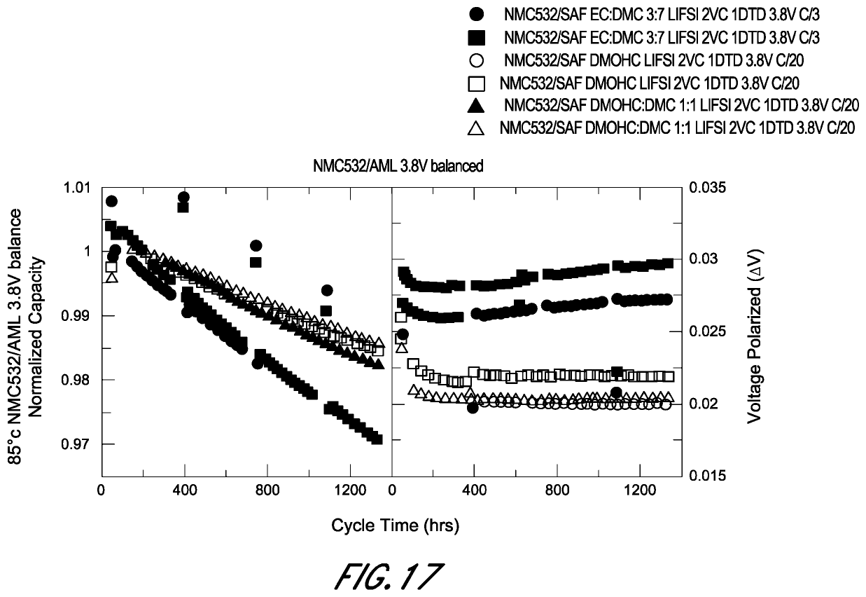

As can be seen in FIG. 15. promising results were obtained with DMOHC mixed with DMC in NMC532/artificial graphite (i.e., “AML”) cells. FIG. 15 shows the normalized discharge capacity versus cycle time of NMC532/artificial graphite cells balanced to 3.8 V tested at an operating temperature of 70° C. including:
(a) LiFSI in 80:20 DMOHC:DMC, with 2% VC and 1% DTD, and C/20 cycling (“LiFSI 80 DMOHC 20 DMC 2VC 1DTD C/20”);
(b) LiFSI in 60:40 DMOHC:DMC, with 2% VC and 1% DTD, and C/20 cycling (“LiFSI 60 DMOHC 40 DMC 2VC 1DTD C/20”);
(c) LiFSI in 40:60 DMOHC:DMC, with 2% VC and 1% DTD, and C/20 cycling (“LiFSI 40 DMOHC 60 DMC 2VC 1DTD C/20”);
(d) LiFSI in 20:80 DMOHC:DMC, with 2% VC and 1% DTD, and C/20 cycling (“LiFSI 20 DMOHC 80 DMC 2VC 1DTD C/20”); and
(e) LiFSI in pure DMOHC, with 2% VC and 1% DTD, and C/20 cycling (“LiFSI DMOHC 2VC 1DTD C/20”).

As seen in FIG. 15, mixed blend ratios of solvents, such as 40% DMOHC and 60% DMC; 60% DMOHC and 40% DMC; or 80% DMOHC and 20% DMC, all provided similar results, with a normalized capacity over 99% after about 2000 cycle hours. The best cycle life results were observed in cells with pure DMOHC.

### Example 11—Cycling Matrix at 85° C.

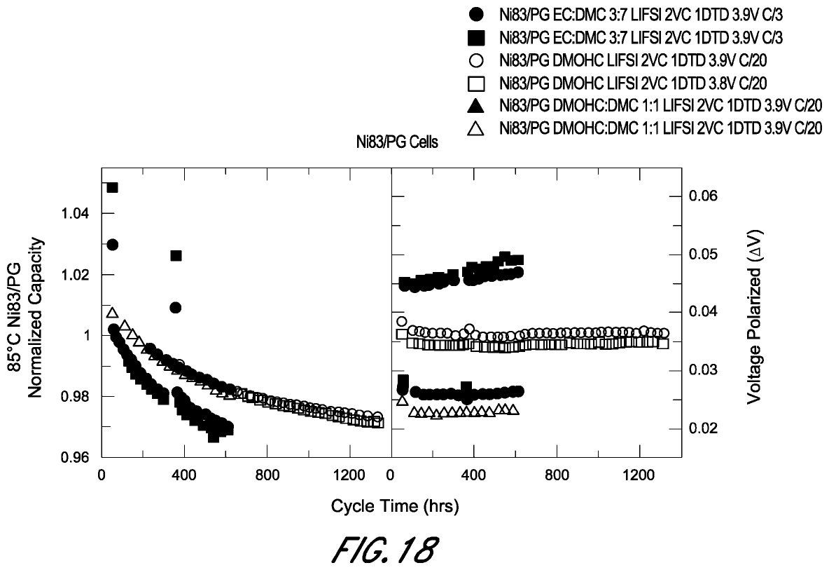

FIG. 16 shows the normalized discharge capacity versus cycle time and voltage polarization versus cycle time of lithium iron phosphate (i.e., “LFP”) cells at and operating temperature of 85° C. including:
(a) LiFSI in 3:7 EC:DMC, with 2% VC and 1% DTD, and C/3 cycling at 3.65 V (“LFP/PG EC:DMC 3:7 LIFSI 2VC 1DTD 3.65V C/3”) (i.e., “control 1”); and
(b) LiFSI in pure DMOHC, with 2% VC and 1% DTD, and C/20 cycling at 3.65 V (two instances of “LFP/PG DMOHC LIFSI 2VC 1DTD 3.65V C/20”).

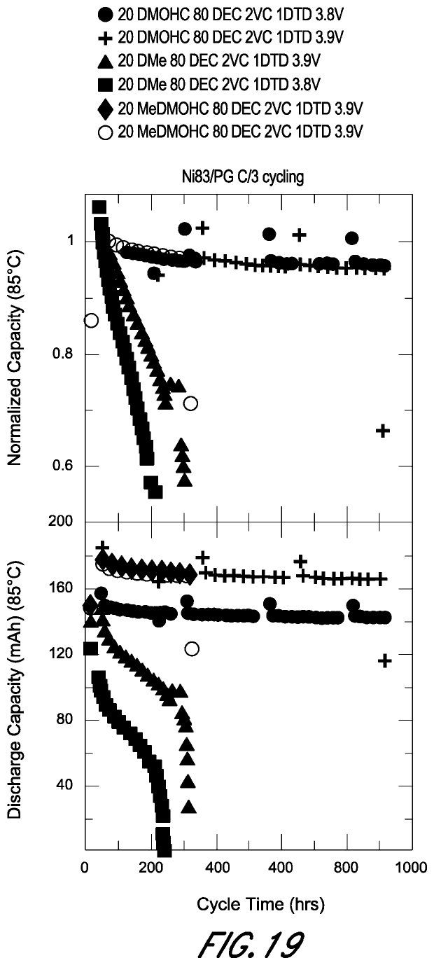

FIG. 17 shows the normalized discharge capacity versus cycle time and voltage polarization versus cycle time of NMC532/artificial graphite (“AML”) cells at and operating temperature of 85° C. including:
(a) LiFSI in 3:7 EC:DMC, with 2% VC and 1% DTD, and C/3 cycling at 3.8 V (two instances of “NMC532/SAF EC:DMC 3:7 LIFSI 2VC 1DTD 3.8V C/3”) (i.e., “control 2”);
(b) LiFSI in pure DMOHC, with 2% VC and 1% DTD, and C/20 cycling at 3.8 V (two instances of “NMC532/SAF DMOHC LIFSI 2VC 1DTD 3.8V C/20”); and
(c) LiFSI in 1:1 DMOHC:DMC, with 2% VC and 1% DTD, and C/20 cycling at 3.8 V (two instances of “NMC532/SAF DMOHC:DMC 1:1 LIFSI 2VC 1DTD 3.8V C/20”).

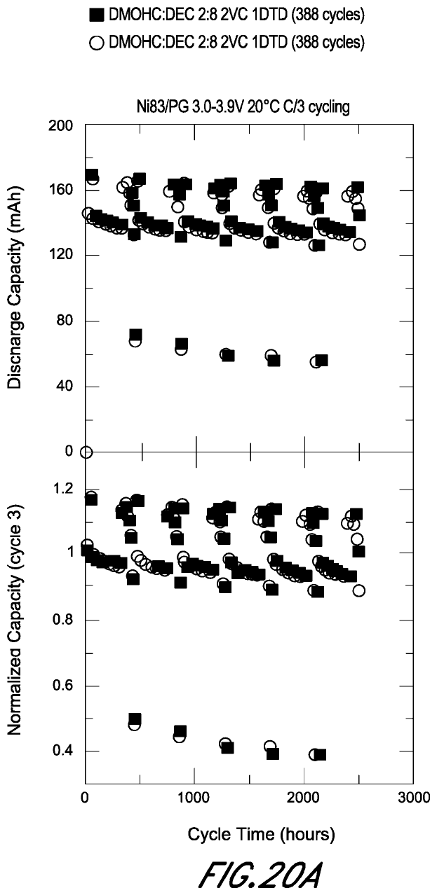

FIG. 18 shows the normalized discharge capacity versus cycle time and voltage polarization versus cycle time of Ni83/PG (Ni83 is LiNi_{0.83}Mn_{0.11}Co_{0.06}O₂ available from Xiamen Tungsten Company (XTC, China)) cells at and operating temperature of 85° C. including:
(a) LiFSI in 3:7 EC:DMC, with 2% VC and 1% DTD, and C/3 cycling at 3.9 V (two instances of “Ni83/PG EC:DMC 3:7 LIFSI 2VC 1DTD 3.9V C/3”) (i.e., “control 3”);
(b) LiFSI in pure DMOHC, with 2% VC and 1% DTD, and C/20 cycling at 3.9 V (two instances of “Ni83/PG DMOHC LIFSI 2VC 1DTD 3.9V C/20”); and
(c) LiFSI in 1:1 DMOHC:DMC, with 2% VC and 1% DTD, and C/20 cycling at 3.9 V (two instances of “Ni83/PG DMOHC:DMC 1:1 LIFSI 2VC 1DTD 3.9V C/20”).

LFP/PG cells utilizing DMOHC as the sole solvent showed improved results over LFP/PG cells utilizing 3:7 EC:DMC as the solvent system. NMC532/artificial graphite cells utilizing DMOHC as the sole solvent performed equivalently to cells with 1:1 DMOHC to DMC during 20-hour charge and discharge cycling at 85° C. For example, the normalized capacity of NMC532/artificial graphite cells balanced to 3.8 V at 85° C. with DMOHC or 1:1 DMOHC:DMC after 700 cycle hours was about 99%, while the normalized capacity of standard electrolyte systems using 3:7 EC:DMC as the solvent reached the same capacity after about 400 cycle hours. Similar results were also observed in Ni83/PG cells. The normalized capacity of Ni83/PG cells at 85° C. with DMOHC or 1:1 DMOHC:DMC after 700 cycle hours was about 98%. In contrast, the normalized capacity of Ni83/PG cells at 85° C. using 3:7 EC:DMC as the solvent reached the same capacity after about 300 cycle hours. Some of the cells have tested for longer times of up to 1,400 hours and continue to show similarly impressive results.

### Example 12—Ni83/PG Cells with DEC as a Co-Solvent

FIG. 19 shows the discharge capacity versus cycle time and normalized discharge capacity versus cycle time of Ni83/PG cells at C/3 cycling (wherein every 50 cycles a C/20:C/20 cycle was performed) and at an operating temperature of 85° C., including:
(a) 1M LiFSI in 20:80 DMOHC:DEC, with 2% VC and 1% DTD, and at 3.8 V (“20 DMOHC 80 DEC 2VC 1 DTD 3.8V”);
(b) 1M LiFSI in 20:80 DMOHC:DEC, with 2% VC and 1% DTD, and at 3.9 V (“20 DMOHC 80 DEC 2VC 1 DTD 3.9V”);
(c) 1M LiFSI in 20:80 DMe-DMOHC:DEC, with 2% VC and 1% DTD, and at 3.9 V (“20 DMe 80 DEC 2VC 1 DTD 3.9V”);
(d) 1M LiFSI in 20:80 DMe-DMOHC:DEC, with 2% VC and 1% DTD, and at 3.8 V (“20 DMe 80 DEC 2VC 1 DTD 3.8V”); and
(e) 1M LiFSI in 20:80 Me-DMOHC:DEC, with 2% VC and 1% DTD, and at 3.9 V (“20 MeDMOHC 80 DEC 2VC 1 DTD 3.9V” and “20 MeDMOHC 80 DEC 2VC 1 DTD 3.9V”).

As seen in FIG. 19, mixed blend ratios of 20% Me-DMOHC and 80% DEC cycled at 3.9 V provided similar results as 20% DMOHC and 80% DEC when cycled at 3.8 V and 3.9 V. In addition, FIG. 19 demonstrates that DMOHC, Me-DMOHC and DMe-DMOHC can be blended with diethyl carbonate (DEC) and used in lithium-ion cells operating at 85° C.

### Example 13—Ni83/PG Cells Tested to 3.9 V with DMOHC and DEC

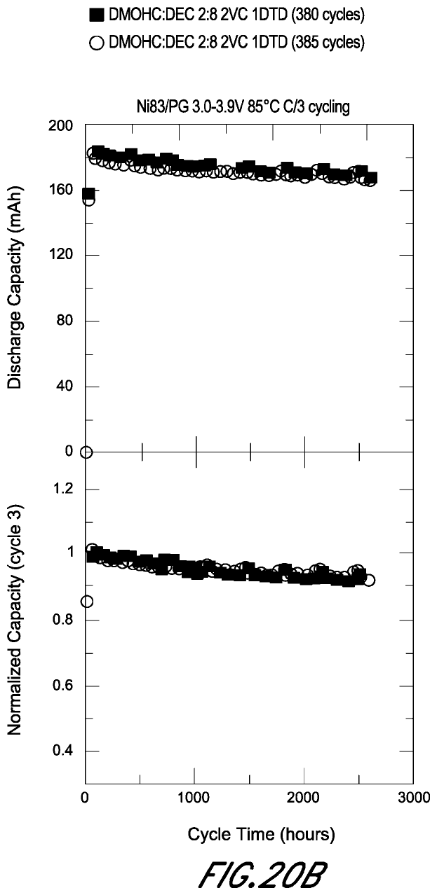

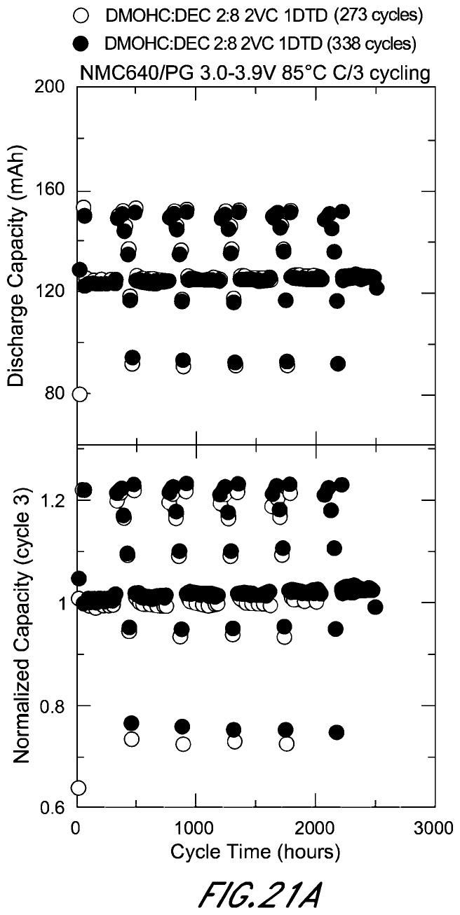

FIG. 20A shows the discharge capacity versus cycle time and normalized discharge capacity versus cycle time of Ni83/PG cells at an operating temperature of 20° C., including:
(a) 1M LiFSI in 20:80 DMOHC:DEC, with 2% VC and 1% DTD, and at 3.9 V for 388 cycles (two instances of “DMOHC:DEC 2:8 2VC 1DTD (388 cycles)”).

The cells were cycled at C/3, wherein every 50 cycles C/20 charge is used consecutively, followed by a C/20, C/10, C/5, C/2, and C discharge was performed.

FIG. 20B shows the discharge capacity versus cycle time and normalized discharge capacity versus cycle time of Ni83/PG cells at an operating temperature of 85° C., including:
(a) 1M LiFSI in 20:80 DMOHC:DEC, with 2% VC and 1% DTD, and at 3.9 V for 380 cycles (“DMOHC:DEC 2:8 2VC 1DTD (380 cycles)”); and
(b) 1M LiFSI in 20:80 DMOHC:DEC, with 2% VC and 1% DTD, and at 3.9 V for 385 cycles (“DMOHC:DEC 2:8 2VC 1DTD (385 cycles)”).

The cells were cycled at C/3. Every 50 cycles, a single C/20:C/20 cycle was performed.

As seen in FIG. 20A Ni83/PG cells including mixed blend ratios of 20% DMOHC and 80% DEC cycled at 3.9 V at an operating temperature of 20° C. retained over 99% of the initial capacity after about 2500 cycle hours. Ni83/PG cells including mixed blend ratios of 20% DMOHC and 80% DEC cycled at 3.9 V at an operating temperature of 85° C. retained over 90% of the initial capacity after about 2500 cycle hours, as demonstrated in FIG. 20B. As can be seen in FIGS. 20A and 20B, electrolytes with solvent blends of DMOHC and DEC operate advantageously at C/3 at both 20° C. and 85° C. with a nickel-rich positive electrode, such as Ni83.

### Example 14—NMC640/PG Cells Tested to 3.9 V with DMOHC and DEC

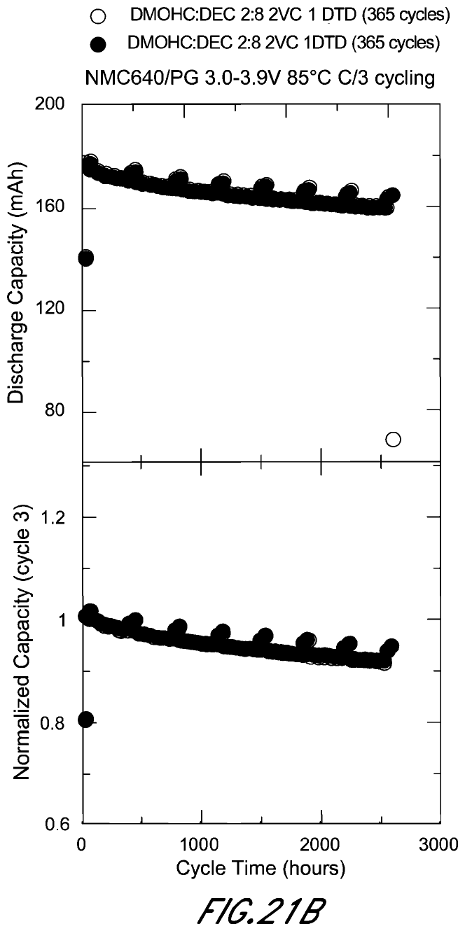

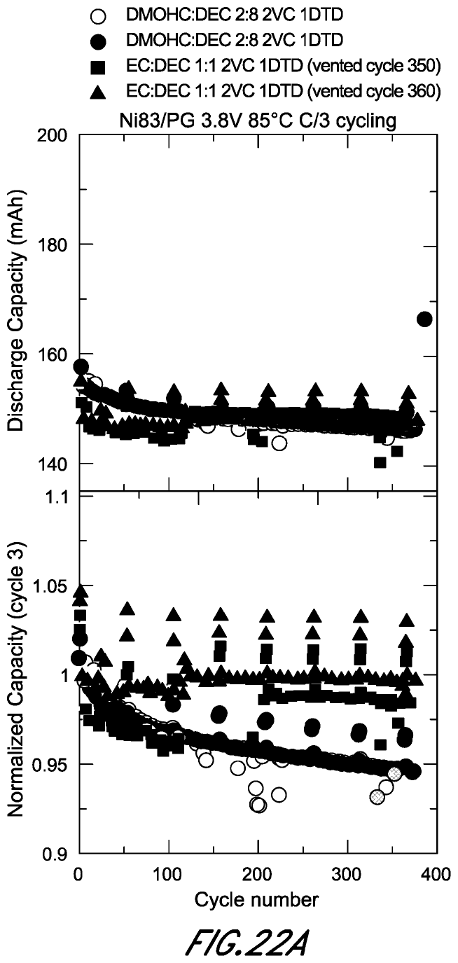

FIG. 21A shows the discharge capacity versus cycle time and normalized discharge capacity versus cycle time of NMC640 cells, including:
(a) 1M LiFSI in 20:80 DMOHC:DEC, with 2% VC and 1% DTD, and at 3.9 V for 273 cycles (“DMOHC:DEC 2:8 2VC 1DTD (273 cycles)”); and
(b) 1M LiFSI in 20:80 DMOHC:DEC, with 2% VC and 1% DTD, and at 3.9 V for 273 cycles (“DMOHC:DEC 2:8 2VC 1DTD (338 cycles)”).

The cells were cycled at C/3 at an operating temperature of 20° C., wherein every 50 cycles a C/20 charge is used consecutively, followed by a C/20, C/10, C/5, C/2, and C discharge was performed.

FIG. 21B shows the discharge capacity versus cycle time and normalized discharge capacity versus cycle time of NMC640/PG cells, including:
(a) 1M LiFSI in 20:80 DMOHC:DEC, with 2% VC and 1% DTD, and at 3.9 V for 365 cycles (two instances of “DMOHC:DEC 2:8 2VC 1DTD (365 cycles)”).

The cells were cycled at C/3 at an operating temperature of 85° C., wherein every 50 cycles, a single C/20:C/20 cycle was performed. As seen in FIG. 21A NMC640/PG cells including mixed blend ratios of 20% DMOHC and 80% DEC cycled at 3.9 V at an operating temperature of 20° C. retained over 99% of the initial capacity after about 2500 cycle hours. NMC640/PG cells including a mixed blend ratios of 20% DMOHC and 80% DEC cycled at 3.9 V at an operating temperature of 85° C. retained over 90% of the initial capacity after about 2500 cycle hours, as demonstrated in FIG. 21B. As can be seen in FIGS. 21A and 21B, electrolytes with solvent blends of DMOHC and DEC operate advantageously at C/3 at both 20° C. and 85° C. with a cobalt-free cathode, such as NMC640.

### Example 15—Ni83/PG Cells Tested to 3.8 V and 3.9 V with DMOHC and DEC

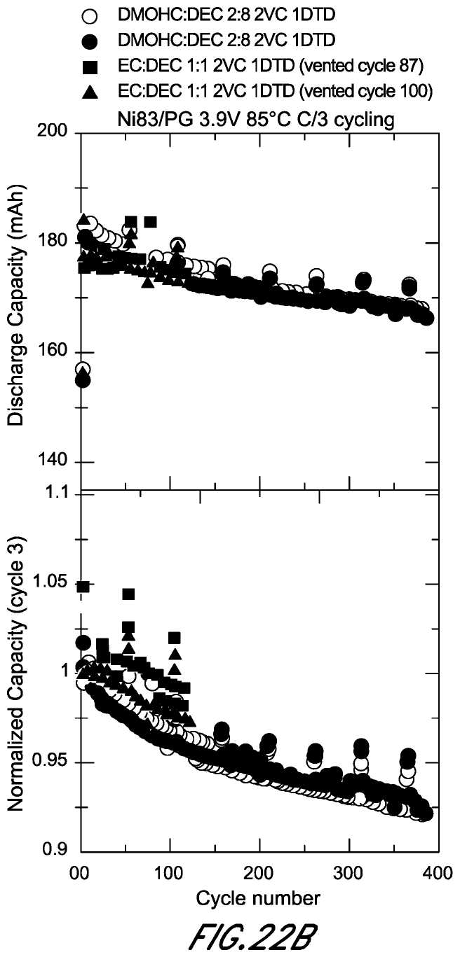

FIG. 22A shows the discharge capacity versus cycle time and normalized discharge capacity versus cycle time of Ni83/PG cells tested to 3.8 V and at an operating temperature of 85° C., including:
(a) 1M LiFSI in 20:80 DMOHC:DEC, with 2% VC and 1% DTD (two instances of “DMOHC:DEC 2:8 2VC 1DTD”); and
(b) 1M LiFSI in in 1:1 EC:DEC, with 2% VC and 1% DTD (“EC:DEC 1:1 2VC 1DTD (vented cycle 350)” and “EC:DEC 1:1 2VC 1DTD (vented cycle 360)”).

Two samples of each cell were tested, and the cells were cycled at C/3:C/3 rate with a full C/20 cycle every 50 cycles.

FIG. 22B shows the discharge capacity versus cycle time and normalized discharge capacity versus cycle time of the same cell compositions as those prepared for FIG. 22A, and were tested to 3.9 V and at an operating temperature of 85° C. Two samples of each cell were tested, and the cells were cycled at C/3:C/3 rate with a full C/20 cycle every 50 cycles.

Due to gas buildup, the baseline electrolyte systems balanced to 3.8 V were vented after 350 cycles and 360 cycles, respectively. As seen in FIG. 22A Ni83/PG cells including mixed blend ratios of 20% DMOHC and 80% DEC cycled at 3.8 V at an operating temperature of 85° C. retained over 97% of the initial capacity after about 400 cycles. Notably, since cells with DMOHC:DEC generated no observable gas over the 380 cycles, electrolytes with solvent blends of DMOHC and DEC bring advantages over EC:DEC with respect to gas generation.

In addition, due to gas buildup, baseline electrolyte systems tested to 3.9 V were vented after 87 cycles or 100 cycles (“EC:DEC 1:1 2VC 1DTD (vented cycle 87)” and “EC:DEC 1:1 2VC 1DTD (vented cycle 100),” respectively). Ni83/PG cells including mixed blend ratios of 20% DMOHC and 80% DEC cycled at 3.9 V at an operating temperature of 85° C. retained over 95% of the initial capacity after over 100 cycles, as demonstrated in FIG. 22B. As can be seen in FIGS. 22A and 22B, Ni83/PG cells including electrolytes with solvent blends of DMOHC and DEC performed as well as or better than baseline electrolyte systems at C/3 and 85° C. when balanced to 3.8 V and 3.9 V and did not demonstrate gas buildup.

### Example 16—Method for Preparing

The general synthesis of preparing compounds of Formula (I) is summarized in Scheme 1, and Table 2 summarizes the various compounds synthesized by the general process.

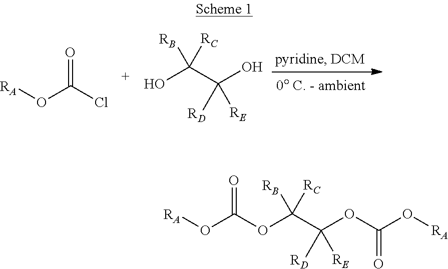

TABLE 2
Summary of various DMOHC derivative compounds synthesized

| COMPOUND | STRUCTURE | R_{A} | R_{B} | R_{C} | R_{D} | R_{E} |
|---|---|---|---|---|---|---|
| DMOHC | 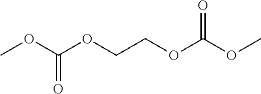 | CH₃ | H | H | H | H |
| Me-DMOHC | 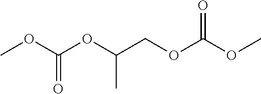 | CH₃ | CH₃ | H | H | H |
| DMe-DMOHC | 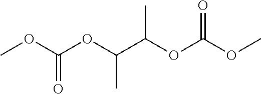 | CH₃ | CH₃ | H | CH₃ | H |
| Et-DMOHC | 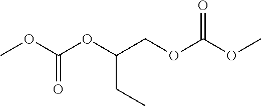 | CH₃ | CH₂CH₃ | H | H | H |
| CF₃-DMOHC | 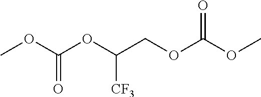 | CH₃ | CF₃ | H | H | H |
| tBu-DMOHC | 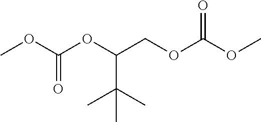 | CH₃ | C(CH₃)₃ | H | H | H |
| sBu-DMOHC | 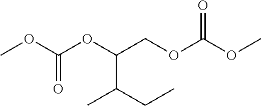 | CH₃ | CH(CH₃)(CH₂CH₃) | H | H | H |

To a dried 1000 mL round bottom flask was added the corresponding 1,2-diol (1 eq., 150 mmnol) and pyridine (2.5 eq., 375 mmol). The flask was then purged with argon. The 1,2-diol and pyridine were then dissolved in anhydrous dichloromethane (DCM, 200 mL). The flask was cooled in an ice bath, and methyl chloroformate (2.5 eq., 375 mmol) was added dropwise in portions of 5 mL over 3 hours. The reaction was then allowed to warm to ambient temperature and left to stir overnight. The following day the reaction was precipitated by the addition of diethyl ether (250 mL) and then vacuum filtered to remove the solid pyridine-HCl. The filtrate, a clear off-white liquid, was then rotovaped to remove excess solvent, and to give the crude product as a viscous liquid. The crude material was then purified via flash column chromatography using silica gel as the stationary phase eluted by cyclohexane:ethyl acetate at ratios of 90:10 to 0:100, or dichloromethane:ethyl acetate at ratios of 95:5 to 0:100. The pure product was isolated after solvent removal under vacuum as a clear-colorless viscous liquid at up to 70% yield. The product was then dried over calcium hydride inside an argon filled glovebox to provide water levels less than 20 ppm. The product was then filtered through a 0.2 μm PTFE membrane to provide the final DMOHC derivative.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An energy storage device, comprising:
a cathode;
an anode;
a separator disposed between the cathode and the anode; and
an electrolyte comprising a solvent and an alkali metal salt, wherein the solvent comprises a compound represented by Formula (I): 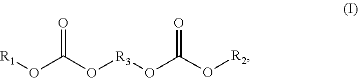
wherein:
R₁ and R₂ are each independently an optionally substituted C₁₋₁₂ alkyl; and
R₃ is an optionally substituted C₁₋₁₂ alkylene.

2. The energy storage device of claim 1, wherein R₁ and R₂ are each independently selected from the group consisting of an optionally substituted methyl, an optionally substituted ethyl, an optionally substituted propyl, an optionally substituted butyl, an optionally substituted iso-propyl, an optionally substituted iso-butyl, and an optionally substituted sec-butyl.

3. The energy storage device of claim 1, wherein the R₁ and R₂ optional substitutions are each independently selected from at least one halogen.

4. The energy storage device of claim 1, wherein the R₃ optional substitutions are selected from the group consisting of at least one C₁₋₁₂ alkyl, C₁₋₁₂ haloalkyl, halogen, and combinations thereof.

5. The energy storage device of claim 1, wherein R₃ is an optionally substituted ethylene or an optionally substituted propylene.

6. The energy storage device of claim 1, wherein the compound is represented by Formula (Ia): 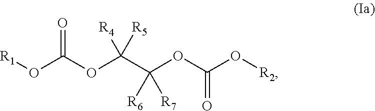
wherein R₄, R₅, R₆, and R₇ are each independently selected from the group consisting of —H, a halogen, a C₁₋₁₂ alkyl, and a C₁₋₁₂ haloalkyl.

7. The energy storage device of claim 6, wherein R₄, R₅, R₆, and R₇ are each independently selected from the group consisting of —H, CH₃—, CH₃CH₂—, CH₃CH₂CH₂—, CH₃CH₂CH₂CH₂—, (CH₃)₂CH—, CH₃CH₂CH(CH₃)—, (CH₃)₃C—, —CF₃, —CHF₂, —CH₂F, —CH₂CF₃, —CH₂CHF₂, —CH₂CH₂F, —CH₂CH₂Cl, and —CH₂CF₂CF₃.

8. The energy storage device of claim 6, wherein R₄ is selected from the group consisting of —H, CH₃—, CH₃CH₂—, CH₃CH₂CH(CH₃)—, (CH₃)₃C—, and —CF₃.

9. The energy storage device of claim 6, wherein R₅ is selected from the group consisting of —H, CH₃—, CH₃CH₂—, CH₃CH₂CH(CH₃)—, (CH₃)₃C—, and —CF₃.

10. The energy storage device of claim 6, wherein R₆ is selected from the group consisting of —H, CH₃—, CH₃CH₂—, CH₃CH₂CH(CH₃)—, (CH₃)₃C—, and —CF₃.

11. The energy storage device of claim 6, wherein R₇ is selected from the group consisting of —H, CH₃—, CH₃CH₂—, CH₃CH₂CH(CH₃)—, (CH₃)₃C—, and —CF₃.

12. The energy storage device of claim 1, wherein the compound is represented by Formula (Ib): 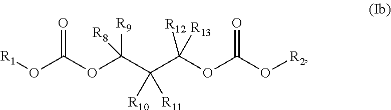
wherein R₈, R₉, R₁₀, R₁₁, R₁₂, and R₁₃ are each independently selected from the group consisting of —H, a halogen, a C₁₋₁₂ alkyl, and a C₁₋₁₂ haloalkyl.

13. The energy storage device of claim 1, wherein the compound of Formula (I) is selected from the group consisting of

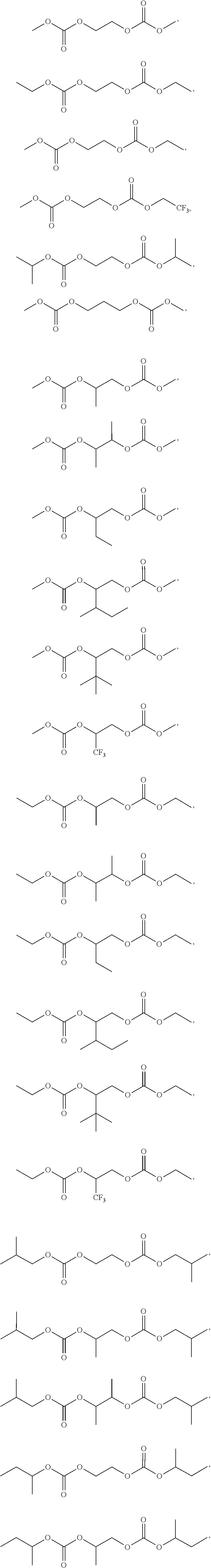

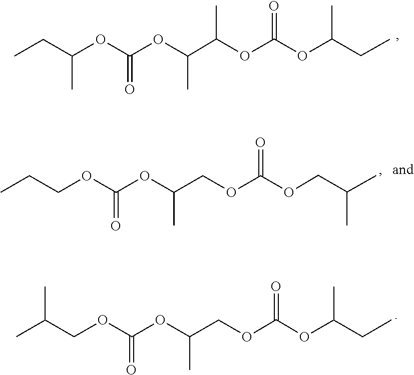

14. The energy storage device of claim 1, wherein the alkali metal salt is a sodium salt.

15. The energy storage device of claim 1, wherein the alkali metal salt is a lithium salt.

16. The energy storage device of claim 15, wherein the lithium salt is LiFSI.

17. The energy storage device of claim 1, wherein the electrolyte further comprises a second solvent selected from the group consisting of ethylene carbonate (EC), propylene carbonate (PC), vinyl ethylene carbonate (VEC), vinylene carbonate (VC), fluoroethylene carbonate (FEC), dimethyl carbonate (DMC), diethyl carbonate (DEC), ethyl methyl carbonate (EMC), methyl acetate (MA), ethyl acetate (EA), propionitrile (PN), acetonitrile (AN), butyrolactone (GBL), and combinations thereof.

18. The energy storage device of claim 17, wherein the ratio between the solvent and second solvent is about 1:4 to about 4:1.

19. The energy storage device of claim 1, wherein the energy storage device is configured to provide at least 96% retention of initial capacity after 2,000 hours of cycling when operated between 3.0 V and 4.3 V.

20. The energy storage device of claim 1, wherein the energy storage device is configured to provide greater than 99% retention of initial capacity after 2000 hours of cycling when operated between 3.0 and 3.8 V at a temperature of at least 70° C.

21. A method of preparing an energy storage device, comprising:
disposing a cathode, an anode, a separator disposed between the cathode and the anode, and an electrolyte within a housing;
wherein the electrolyte comprises a solvent and an alkali metal salt, wherein the solvent comprises a compound represented by Formula (I): 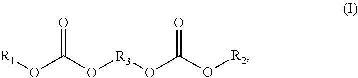
wherein:
R₁ and R₂ are each independently an optionally substituted C₁₋₁₂ alkyl; and
R₃ is an optionally substituted C₁₋₁₂ alkylene.
